(19) United States
(12) Patent Application Publication
(10) Pub. No.: US 2016/0253632 A1
(43) Pub. Date: Sep. 1, 2016

(54) METHOD FOR CONTROLLING CALENDAR AND RECORDING MEDIUM HAVING PROGRAM FOR PERFORMING THE SAME

(71) Applicant: Eun Uk WON, Guri-si (KR)

(72) Inventor: Eun Uk WON, Guri-si (KR)

(21) Appl. No.: 14/912,904

(22) PCT Filed: Jul. 3, 2015
(86) PCT No.: PCT/KR2015/006868

§ 371 Date: Feb. 18, 2016

(30) Foreign Application Priority Data
Jul. 3, 2014 (KR) 10-2014-0083097
Jul. 3, 2014 (KR) 10-2014-0083098
Jul. 3, 2014 (KR) 10-2014-0083100
Jul. 3, 2014 (KR) 10-2014-0083101
Jul. 3, 2014 (KR) 10-2014-0083102

(51) Int. Cl. G06Q 10/10; G06F 3/0484; H04W 4/02; G06F 3/0482

(52) U.S. Cl. CPC G06Q 10/1095; G06F 3/0482; G06F 3/04842; H04W 4/021

(57) ABSTRACT

Weather information is displayed on an electronic device according to a method that includes receiving weather information corresponding to time points, wherein the weather information comprises weather type information. First weather information corresponding to a current time point is selected from among the weather information. A first weather object corresponding to first weather type information of the first weather information is displayed through a display of the electronic device. At least one second weather information having second weather type information different from the confirmed first weather type information is checked from among weather information corresponding to time points after the current time point. A second weather object corresponding to the second weather type information of the confirmed second weather information is displayed through the display. A difference value between a time point corresponding to the second weather information and the current time point are displayed through the display.

### TECHNICAL FIELD

The present invention relates to a method of controlling a calendar on an electronic device and a recording medium having a program for performing the same.

More specifically, the present invention relates to a method of controlling a calendar running on an electronic device such as a desktop computer and a smartphone through an operating system, a web browser, or a calendar application, and to a recording medium having a program thereon for performing the same.

### BACKGROUND ART

With the development of portable electronic devices such as smartphones, user demand has recently increased for calendar programs that manage personal schedules by using electronic devices such as smartphones and/or desktop computers.

Since many advantages arise, such as users being able to easily check their schedules anywhere, when schedules are managed in linkage with smartphones and desktop computers, users are eagerly making use of calendar programs. Due to this trend, programs for managing schedules are loaded by default into electronic devices such as smartphones from their launch for shipping, and calendar applications for easy schedule management are selling well in app stores that distribute smartphone applications.

However, conventional calendar applications are inconvenient in many ways when inputting (or registering) a schedule and modifying (or deleting or changing) the schedule.

### DISCLOSURE

### Technical Problem

The present invention provides a method of controlling a calendar which a user may use more conveniently and usefully and a recording medium having a program for performing the same.

### Technical Solution

According to an aspect of the present invention, provided is a method of displaying weather information on an electronic device. The method includes: receiving weather information including first weather information on a first weather at a first time point and second weather information on a second weather at a second time point that is after the first time point, wherein the first weather and the second weather are different; displaying a first weather object corresponding to the first weather from among a plurality of weather object groups through a display of the electronic device; displaying a second weather object corresponding to the second weather from among the plurality of weather object groups through the display; and displaying a difference value between the first time point and the second time point through the display.

The weather information may include weather type information and meteorological information and the meteorological information may include at least one of temperature information, humidity information, precipitation information, precipitation probability information, wind speed information, and wind direction information.

The weather type information may include at least sunny, cloudy, rainy, and snowy.

The plurality of weather object groups may include objects respectively corresponding to a plurality of weather types.

The method may further include displaying the weather information at the first time point at a position corresponding to a display position of the first weather object.

The method may further include obtaining a position of the electronic device, wherein the weather information is about the obtained position of the electronic device.

According to another aspect of the present invention, provided is a method of displaying weather information on an electronic device. The method includes: receiving a plurality of weather information corresponding to a plurality of time points, wherein each of the weather information includes weather type information; selecting first weather information corresponding to a current time point from among the plurality of weather information; displaying a first weather object corresponding to first weather type information of the first weather information through a display of the electronic device; checking at least one second weather information having second weather type information different from the confirmed first weather type information, from among weather information corresponding to time points after the current time point; displaying a second weather object corresponding to the second weather type information of the confirmed second weather information through the display; and displaying a difference value between a time point corresponding to the second weather information and the current time point through the display.

According to another aspect of the present invention, provided is a method of controlling a calendar including weather information in an electronic device. The method includes: displaying a date through a display of the electronic device; receiving a weather function activation request at a first time point; selecting dates before the first time point from among the displayed dates; obtaining weather information corresponding to the selected dates; and displaying the obtained weather information to correspond to positions of the selected dates through the display.

The receiving of the weather function activation request may include receiving a selection input from a user by a weather function object including a first weather object corresponding to the first time point and a second weather object corresponding to a second time point.

Weather type information corresponding to the first time point and weather type information corresponding to the second time point may be different.

The weather object may include a difference value between the first time point and the second time point.

The selecting of the dates may include: selecting one of the first weather object and the second weather object, included in the weather function object; and selecting dates having weather type information identical to weather type information corresponding to the selected weather object.

The displaying of the weather information may include displaying a weather object corresponding to weather type information corresponding to the selected date from among a plurality of date objects, through the display.

The displaying of the weather information may include displaying a maximum value and a minimum value about at least one meteorological information included in the weather information to correspond to the weather object through the display.

The displaying of the weather information may include displaying the weather information at schedule information positions respectively corresponding to the displayed dates and displaying schedule information corresponding to the displayed dates.

The displaying of the weather information may include no longer displaying the schedule information at the schedule information positions and displaying the weather information instead of the schedule information.

Provided is a recording medium, in which a program for executing one of the above methods is recorded.

According to another aspect of the present invention, an electronic device includes: a communication unit; a display; and a control unit configured to receive weather information including first weather information on a first weather at a first time point and second weather information on a second weather at a second time point that is after the first time point through the communication unit, display a first weather object corresponding to the first weather from among a plurality of weather object groups through the display, display a second weather object corresponding to the second weather from among the plurality of weather object groups through the display, and display a difference value between the first time point and the second time point through the display, wherein the first weather and the second weather are different.

### Advantageous Effects

According to the present invention, when trying to manage a schedule through a calendar application installed on an electronic device, a user may manage a schedule more conveniently and usefully.

Especially, according to the present invention, weather information may be displayed through a weather function object, and very intuitive and effective information on the current weather information and future weather information may be obtained through a very limited area according to the use of the weather function object.

### DESCRIPTION OF DRAWINGS

FIG. 1 is a block diagram of an electronic device according to embodiments of the present invention.

FIG. 2 is a view illustrating a main Graphical User Interface (GUI) of a calendar according to an embodiment of the present invention.

FIG. 3 is a view illustrating a GUI GUI1 for registering a schedule on a selected date through a calendar according to an embodiment of the present invention.

FIG. 4 is a view illustrating a User Interface for continuous schedule input according to an embodiment of the present invention.

FIG. 5 is a flowchart illustrating a method of displaying weather information according to an embodiment of the present invention.

FIG. 6 is a view illustrating a weather function object for displaying weather information according to an embodiment of the present invention.

FIG. 7 is a flowchart illustrating a method of controlling a calendar including weather information according to an embodiment of the present invention.

FIG. 8 is a view when a weather function object WFOB is included in the main GUI according to an embodiment of the present invention.

FIG. 9 is a view illustrating part of a GUI provided after a weather function is activated according to an embodiment of the present invention.

FIG. 10 is a flowchart illustrating a method of controlling a calendar according to another embodiment of the present invention.

FIG. 11 is a view illustrating a schedule check function activation button according to an embodiment of the present invention.

FIG. 12 is a view illustrating a UI provided for selecting a schedule property according to an embodiment of the present invention.

FIG. 13 is a view illustrating a screen for displaying a date object corresponding to a selected schedule property according to an embodiment of the present invention.

FIGS. 14 and 15 are views illustrating a method of controlling a calendar according to another embodiment of the present invention.

FIG. 16 is a flowchart illustrating a method of controlling a calendar according to another embodiment of the present invention.

FIGS. 17 to 21 are views illustrating a method of controlling a calendar according to another embodiment of the present invention.

FIG. 22 is a flowchart illustrating a method of controlling a calendar according to another embodiment of the present invention.

FIGS. 23 to 28 are views illustrating a UI for providing at least one date having advertisement information depending on a control method of a calendar according to another embodiment of the present invention.

FIG. 29 is a flowchart illustrating a method of controlling a calendar according to another embodiment of the present invention.

FIG. 30 is a flowchart illustrating a method of controlling a calendar according to another embodiment of the present invention.

FIGS. 31 to 33 are views illustrating a method of controlling a calendar according to another embodiment of the present invention.

### BEST MODE

The objects, features, and advantages of the present invention become more apparent from the following detailed description with reference to the accompanying drawings. However, various modifications are possible in various embodiments of the present invention and thus, specific embodiments are illustrated in drawings and related detailed descriptions are listed.

In the accompanying drawings, the thicknesses of layers and areas are exaggerated for clarity and also, it will be understood that when an element or a layer is referred to as being “son” another element or layer, it may be directly on the other element or intervening elements may also be present. The same reference numerals denote the same elements in principle throughout the specification.

Additionally, detailed descriptions of well-known functions or configurations will be omitted since they would obscure the present invention in unnecessary detail. Additionally, numbers (for example, first and second) used in the description of this specification are just identification symbols for distinguishing one component from another component.

Hereinafter, an electronic device according to the present invention will be described in detail with reference to the accompanying drawings. The suffixes “module” and “unit” for components used in the description below are assigned or mixed in consideration of easiness in writing the specification and do not have distinctive meanings or roles by themselves.

Electronic devices described in this specification may include fixed terminals such as digital TVs and desktop computers in addition to mobile terminals such as smartphones, laptop computers, digital broadcast terminals, personal digital assistants (PDAs), portable multimedia players (PMPs), and navigation systems.

1. Configuration of Electronic Device

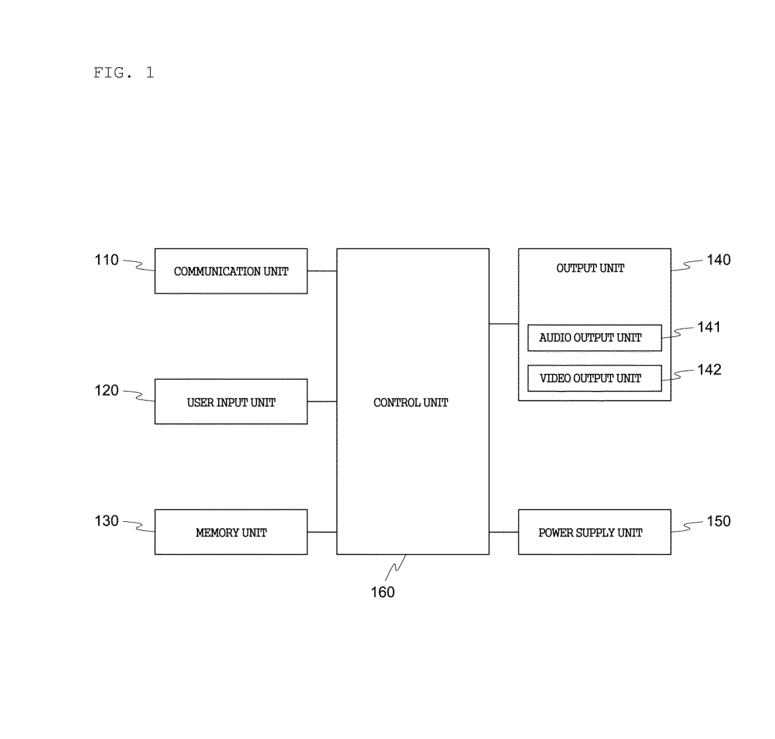

FIG. 1 is a block diagram of an electronic device according to embodiments of the present invention.

The electronic device 100 may include a communication unit 110, a user input unit 120, a memory unit 130, an output unit 140, a power supply unit 150, and a control unit 160. Components shown in FIG. 1 are not necessary, so that an electronic device having less or more components that may be implemented.

Hereinafter, the components are described one by one.

The communication unit 110 may include at least one module for allowing communication between the electronic device 100 and a communication system or between the electronic device 100 and a network where the electronic device 100 is located.

The communication unit 110 may communicate with an external electronic device and/or network through a wired method and also communicate with an external electronic device and/or network through a wireless method.

On the other hand, the communication unit 110 may include a short-range communication module. The short-range communication module refers to a module for short-range communication. As short range communication technology, provided are Bluetooth, Radio Frequency Identification (RFID), infrared Data Association (IrDA), Ultra Wideband (UWB), ZigBee, WiHD, and WiGig.

Additionally, the communication unit 110 may include a location information reception module. The location information reception module is a module for checking or obtaining the location of the electronic device 100. A representative example of the location information module includes a Global Positioning System (GPS) module. According to the current technology, the GPS module 115 may calculate information on a distance from one point (or entity) to at least three satellites and information on a time at which the distance information is measured and then, calculate three-dimensional location information according to the latitude, longitude, and altitude of the one point (or entity) at a certain time by applying triangulation to the calculated distance information. Furthermore, a method for calculating location and time information by using three satellites and correcting errors of the calculated location and time information by using another satellite is being also used.

The electronic device 100 may receive weather related information, schedule related information stored in an external electronic device, and advertisement related information relating to a specific date, through the communication unit 110.

The user input unit 120 generates input data for controlling operations of a terminal through a user. The user input unit 120 may include a key pad, a dome switch, a touch pad (for example, static pressure/electrostatic), a jog wheel, and a jog switch. Moreover, the user input unit 120 may not be a component included in the electronic device 100 itself and may be additional electronic device connected wiredly/wirelessly through an interface unit (not shown) equipped in the electronic device 100. For example, the user input unit 120 may be implemented in the form of an additional electronic device for receiving data from a user, for example, a mouse and a keyboard used in connection to an electronic device.

The memory unit 130 may store a program for operations of the control unit 160 and temporarily store input/output data (for example, schedule related information and a user input for operating a calendar). The memory unit 130 may store data on various patterns of vibrations and sounds outputted during a touch input on the touch screen.

The memory unit 130 may include at least one type of storage medium among flash memory type, hard disk type, multimedia card micro type, card type memory (for example, SD or XD memory), random access memory (RAM), static random access memory (SRAM), read-only memory (ROM), electrically erasable programmable read-only memory (EEPROM), programmable read-only memory (PROM), magnetic memory, magnetic disk, and optical disk. The electronic device 100 may operate in relation to a web storage for performing a storage function of the memory unit 130 on internet.

The output unit 140 used for generating a visual or auditory output may include an audio output unit 141 and a video output unit 142.

The audio output unit 141 outputs information relating to the electronic device 100 audibly. That is, the audio output unit 141 outputs sound signals relating to a function performed in the electronic device 100. For example, when the electronic device 100 is a smartphone, it may audibly output data received from the communication unit 110 during call signal reception, a call mode, a recording mode, a voice recognition mode, or a broadcast reception mode. Alternatively, the audio output unit 141 may audibly output audio data stored in the memory unit 130. The audio output unit 141 may be implemented with a receiver, a speaker, and a buzzer.

The video output unit 142 visually outputs information processed in the electronic device 100. For example, in the case that the electronic device 100 is a smartphone, if a mode of the smartphone is a call mode, a call related User Interface (UI) or Graphic User Interface (GUI) may be displayed and if a calendar application is running on the electronic device 100, a UI or GUI provided from the calendar application may be displayed.

The video output unit 142 may include at least one of a liquid crystal display, a thin film transistor-liquid crystal display, an organic light-emitting diode, a flexible display, and a 3D display.

Some of them may be configured with a transparent type or an optical transmission type through which the outside is seen. This may be called a transparent display and its representative example may include a Transparent LCD of the transparent display. The rear structure of the video output unit 142 may be also configured with an optical transmission type structure. Through such a structure, a user may see an object at the rear of a terminal body through an area that the video output unit 142 of the terminal body occupies.

The video output unit 142 may exist more than two according to an implementation form of the electronic device 100. For example, a plurality of display units may be separately or integrally disposed on one surface or may be disposed on different surfaces in the electronic device 100. Alternatively, the video output unit 142 may be divided into two or more areas logically.

When the video output unit 142 and a sensor (hereinafter referred to as a touch sensor) for detecting a touch operation form a mutual layer structure (hereinafter referred to as a touch screen), the video output unit 142 may be used as an input device in addition to an output device. The touch sensor, for example, may have a form of a touch film, a touch sheet, and a touch pad.

The touch sensor may be configured to convert a pressure applied to a specific portion of the video output unit 142 or changes in capacitance occurring at a specific portion of the video output unit 142 into electrical input signals. The touch sensor may be configured to detect a pressure during touch in addition to a touched position and area.

When there is a touch input on the touch sensor, signal(s) corresponding thereto is/are sent to a touch controller. The touch controller processes the signal(s) and then transmits corresponding data to the control unit 160. Therefore, the control unit 160 may recognize which area of the video output unit 142 is touched.

The power supply unit 150 supplies power necessary for operations of the electronic device 100. The power supply unit 150 may supply power, applied from the outside, to each component necessary for operations of the electronic device 100, and may supply power to the each component while storing electrical energy like a battery.

The control unit 160 typically controls overall operations of the electronic device 100.

Hereinafter, a method of controlling a calendar is described according to the present invention.

Various embodiments described herein may be implemented in recording media readable by computers or devices similar thereto through software, hardware, or a combination thereof.

Through hardware implementations, embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing functions. In some cases, such embodiments may be implemented by the control unit 160.

Through software implementations, embodiments relating to procedures or functions may be implemented together with an additional software module for performing at least one function or operation. Software code may be implemented by a software application written in an appropriate program language. Additionally, the software code may be stored in the memory unit 160 and executed by the control unit 180.

2. Method of Controlling Calendar

Hereinafter, various functions of an electronic device where a calendar according to one aspect of the present invention is running are described and a control method necessary for performing each function is described.

(1) Description of Main Screen

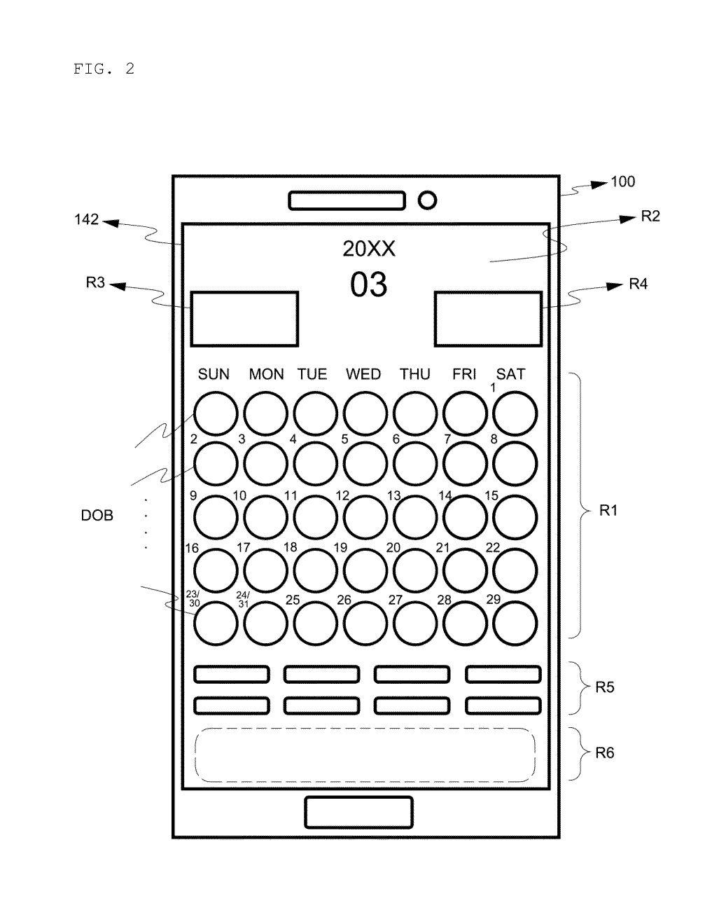

FIG. 2 is a view illustrating a main GUI of a calendar according to an embodiment of the present invention.

Referring to FIG. 2, the main GUI is displayed through the video output unit 142 (hereinafter referred to as a display unit or a display) of the electronic device 100

The main GUI may include a plurality of areas for providing a variety of information and may include a plurality of areas for receiving several inputs from a user in order for operations of the calendar.

The main GUI may include a first area R1 (hereinafter referred to as a schedule display area) for displaying a date of the calendar and a schedule corresponding to a corresponding date.

A date may be displayed in the first area R1 and a date object DOB corresponding each date may be displayed together with the displayed date.

Information relating to a corresponding date according to each selected function may be displayed on the date object DOB. For example, various schedules registered on a corresponding date may be compressively displayed on the date object DOB; weather information of a corresponding date may be compressively displayed on the date object DOB; or whether a corresponding schedule is in a selected schedule property may be displayed through the date object DOB.

Also the date object DOB may operate as a function button.

For example, when a user touches the date object DOB (when the output unit and the user input unit of the electronic device 100 are a touch screen) or clicks a mouse (when the electronic device 100 is a desktop computer or a laptop computer and the user input unit is a mouse), the electronic device 100 may display information relating to a corresponding date on the selected date object DOB more specifically.

For another example, when a user touches the date object DOB or clicks them by using a mouse, the electronic device 100 may provide a UI for registering a new schedule to a date corresponding to the selected date object DOB.

The main GUI may include a second area R2 (hereinafter referred to as a calendar range area) for displaying a range of a date being displayed through the calendar.

The main GUI may include third to fifth areas R3, R4, and R5 for activating various calendar functions provided by embodiments of the present invention. Function objects corresponding to various functions may be displayed in the third to fifth areas R3, R4, and R5 and the function objects operate as buttons for activating various functions. For example, when a user touches the function objects or click them by using a mouse, the electronic device 100 may activate a function corresponding to the selected function object. Moreover, the function objects may operate information display areas for displaying information relating to a function corresponding to each of the function objects if necessary.

The main GUI may include a sixth area R6 (hereinafter referred to as an information display area) for displaying necessary information provided by the calendar.

(2) Schedule Input and Schedule Check

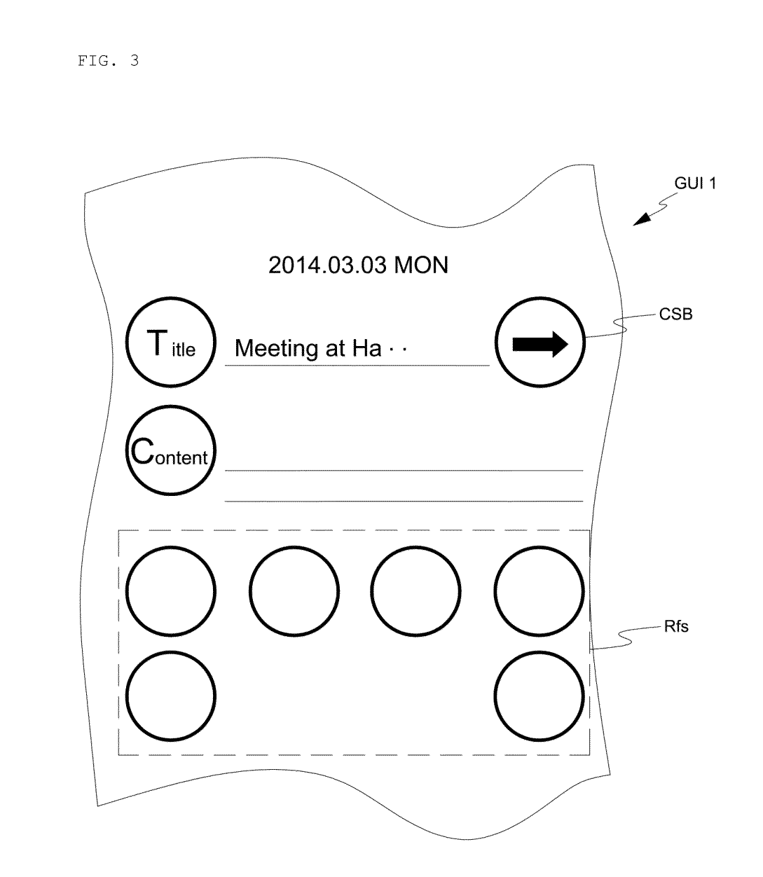

FIG. 3 is a view illustrating a GUI GUI1 for registering a schedule to a date selected through a calendar according to an embodiment of the present invention.

When a user touches a date object DOB (for example, a date object corresponding to 2014 Mar. 3) corresponding to a specific date included in the main GUI shown in FIG. 2 or clicks it by using a mouse, the GUI GUI1 shown in FIG. 3 may be displayed through the display unit 142 of the electronic device 100.

Alternatively, when a user touches a function object for registering a schedule among function objects included in the third to fifth areas R3, R4, and R5 of the main GUI shown in FIG. 2 or clicks it by using a mouse, the GUI GUI1 may be displayed through the display unit 142.

Referring to FIG. 3, the GUI GUI1 may include an area for receiving the title of a schedule and an area for receiving the details of a schedule, and furthermore may include a function selection area Rfs where various function selection buttons are provided for selecting functions necessary for registering the schedule.

A user may input a variety of information for registering a schedule to a selected date through the GUI GUI1. Although not shown clearly in the drawings, the GUI GUI1 may provide a UI for inputting information on a schedule start time point (that is, a time at which a schedule starts during 24 hours), an end time point (that is, a time at which a schedule ends during 24 hours), and a schedule location.

(2-1) Input of Continuous Schedule

Especially, a calendar according to an embodiment of the present invention provides a convenient UI for inputting a schedule progressing over continuous dates.

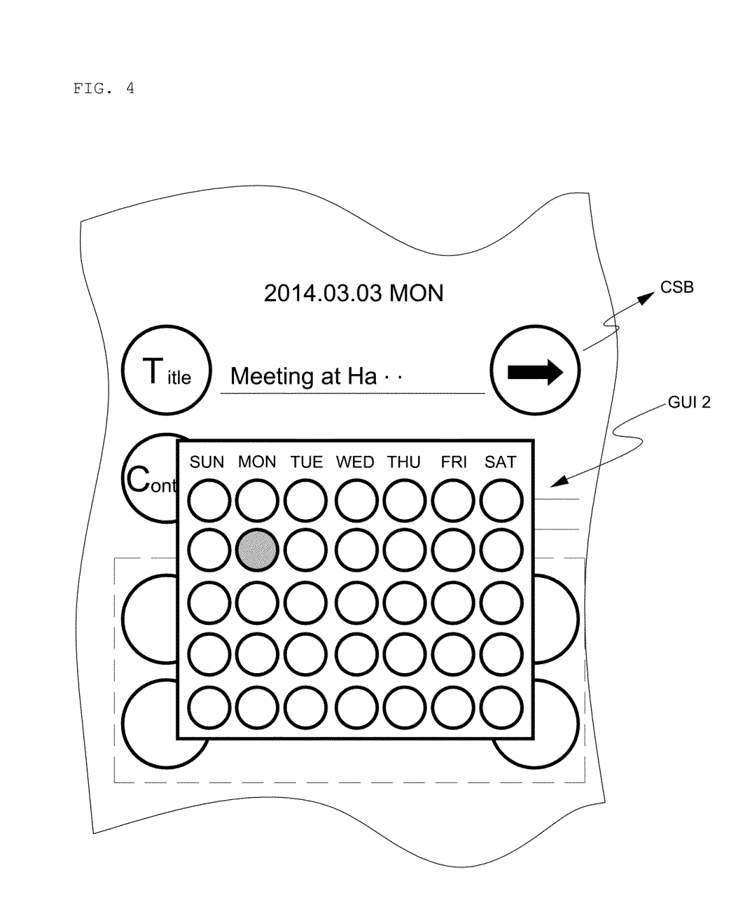

FIG. 4 is a view illustrating a UI for inputting a continuous schedule according to an embodiment of the present invention.

A GUI GUI2 shown in FIG. 4 may be displayed when a continuous schedule button CSB included in the GUI GUI1 shown in FIG. 3 is selected.

As shown in FIG. 4, once the continuous schedule button CSB is selected, the GUI GUI2 in a calendar form may be displayed and include a plurality of date objects corresponding to a plurality of dates. One date object (hereinafter referred to as a selection date object) corresponding to a date selected to register a schedule among the plurality of date objects may be displayed with a different display property than other date objects. For example, the selection date object may have a different color than other date objects. For another example, the selection date object may be displayed in a blinking manner unlike other date objects. As shown in FIG. 4, only the selection date object is displayed with gray and other date objects are displayed with white.

Then, a user may select at least one date object among other date objects included in the GUI GUI2 and accordingly, the electronic device 100 may select the latest date among at least one date corresponding to the at least one selected date object and set the selected date as the end date of a schedule to be registered.

As providing the GUI GUI2, a user may easily register a schedule to be registered over continuous dates. That is, a user may easily select the start date and the end date of a continuous schedule with only a total of two operations including one operation for selecting the continuous schedule button CSB and one operation for selecting the end date of a schedule.

(3) Method of Displaying Weather Information

A calendar according to an embodiment of the present invention may display weather information according to a very simple method unlike a conventional method.

Hereinafter, the weather information refers to information including weather type information on a specific time point and a specific region and meteorological information.

The weather type information refers to information that represents corresponding weather representatively and concisely like the words “sunny”, “cloudy” “rainy” and “snowy.”

Additionally, the meteorological information refers to information including parameters for defining the properties of weather measured or predicted by a weather station of the National Weather Service, for example, at least one of temperature information, humidity information, rainfall information, precipitation probability information, wind velocity information, and wind direction information.

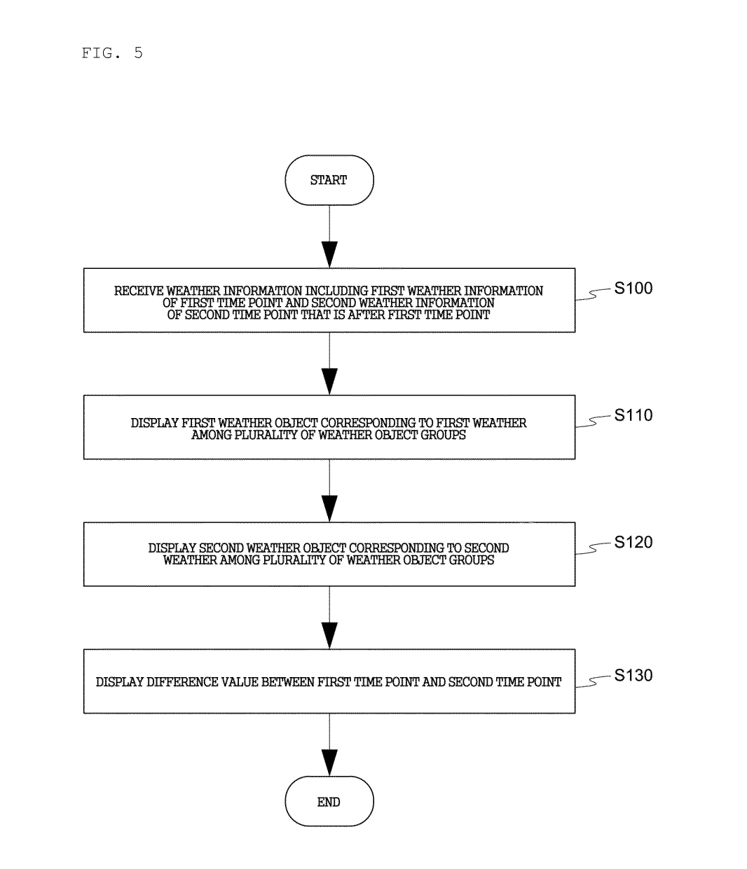

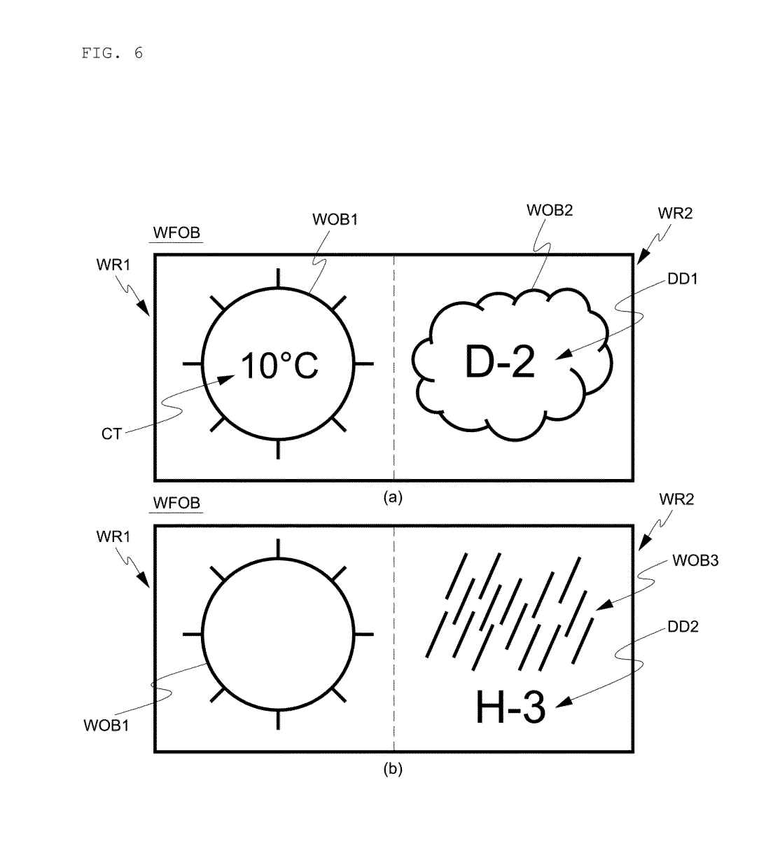

FIG. 5 is a flowchart illustrating a method of displaying weather information according to an embodiment of the present invention and FIG. 6 is a view illustrating a weather function object for displaying weather information according to an embodiment of the present invention.

Referring to FIG. 5, a method of displaying weather information according to an embodiment of the present invention may include receiving first weather information on the first weather of the first time point and second weather information on the second weather of the second time point after the first time point in operation S100, displaying a first weather object corresponding to the first weather among a plurality of weather object groups through the display 142 of the electronic device 100 in operation S110, displaying the second weather object corresponding to the second weather among the plurality of weather object groups through the display 142 in operation S120, and displaying a difference value of the first time point and the second time point through the display 142 in operation S130. At this point, the first weather and the second weather may be different from each other.

The electronic device 100 may receive the first weather information and the second weather information from the outside in operation S100.

That is, the first weather information of the first time point and the second weather information of the second time point may be information received from the outside through the communication unit 110. The electronic device 100 may receive the weather information periodically from the outside and may perform update irregularly by receiving the weather information. Alternatively, the electronic device 100 may receive the weather information from the outside only if there is a user's request.

In receiving the weather information, a plurality of future weather information may be received at one time from the outside. That is, in receiving the weather information, all future weather information corresponding to a period of the future 30 days may be received at one time from the outside. Moreover, the received weather information may be updated by weather information that is to be received again after that. That is, weather information on the first future time point received at the first reception time point may be different from weather information on the first future time point received at the second reception time point later than the first reception time point and at this point, weather information on the future time point at the first reception time point may be changed into weather information on the first future time point received at the second reception time point.

The electronic device 100 may store the received weather information in the memory unit 130 and if the weather information is required depending on an operation according to an embodiment of the present invention, properly utilize the weather information stored in the memory unit 130.

The memory unit 130 may store weather information on the current and/or weather information on the future based on the current time point, and store/maintain weather information on the already received past.

Moreover, the first weather information of the first time point and the second weather information of the second time point may be weather information on the current location of the electronic device 100. That is, the electronic device 100, as mentioned above, may calculate the current location through a location information reception module and obtain the first weather information and the second weather information based on the calculated location.

However, the location information for obtaining the weather information may not necessarily be the current location information and may be set to another location instead of the current location according to a user's request, a request of operating system of the electronic device 100, and/or a request of another application installed on the electronic device 100.

Then, the electronic device 100 may display a first weather object corresponding to the first weather among a plurality of weather object groups through the display of the electronic device 100 in operation S110 and a second weather object corresponding to the second weather among the plurality of weather object groups through the display of the electronic device 100 in operation S120. At this point, the electronic device 100 may display a difference value of the first time point and the second time point through the display in operation S130.

Hereinafter, a method of displaying the first weather object and the second weather object is described in detail with reference to FIG. 6.

Referring to FIG. 6, a weather function object WFOB according to an embodiment of the present invention may include a first weather area WR1 and a second weather area WR2.

The first weather area WR1 may represent at least part of first weather information on weather of a first time point.

For example, as shown in FIG. 6A, a first weather object WOB1 corresponding to a first weather information type of weather at the current time point (for example, the first time point) may be displayed in the first weather area WR1. Although it is shown in FIG. 6A that the weather object WOB1 corresponding to “sunny” is displayed in the first weather area WR1 when a weather type at the current time point (for example, the first time point) is “sunny,” if a weather type at the current time point (for example, the first time point))) is “cloudy,” the weather object WOB2 corresponding to “cloudy” may be displayed in the first weather area WR1.

Furthermore, in addition to the first weather object WOB1, a value of at least one (for example, temperature information) of first meteorological information at the current time point (for example, the first time point) may be displayed in the first weather area WR1. Of course, both the weather object WOB1 and the value of the first meteorological information are not required to be displayed in the first weather area WR1 and as shown in FIG. 6B, it is regardless that only the first weather object WOB1 is displayed.

Moreover, although it is described above that the first time point is the current time point, the first time point is not necessarily the current time point and an arbitrarily selected time point from a user's input may be the first time point.

The second weather area WR2 may represent at least part of second weather information on weather of a second time point. Furthermore, the second weather area WR2 may represent a remaining period to the second time point from the first time point.

The second time point is selected as a time point having weather type information different from the first weather type information among time points after the first time point in consideration of the first weather type information of the first weather information displayed in the first weather area WR1.

For example, when the weather type of a first time point is “sunny,” the weather type after 6 hours from the first time point is “sunny,” the weather type after 12 hours from the first time point is “sunny,” but the weather type after 18 hours from the first time point is “cloudy,” a time point after the 18 hours from the first time point is selected as the second time point.

For another example, when the weather type of a first time point is “sunny,” the weather type after one day from the first time point is “sunny,” the weather type after two days from the first time point is “sunny,” but the weather type after three days from the first time point is “rainy,” a time point after the 3 days from the first time point is selected as the second time point.

When the second time point is selected, the electronic device 100 may check the second weather information corresponding to the second time point and display the second weather object WOB2 corresponding to the second weather type information included in the second weather information, in the second weather area WR2.

As mentioned above, when weather information is displayed through a weather function object WFOB, very intuitive information on weather information on the current (for example, the first time point) and weather information on the future (for example, the second time point) may be obtained through a very limited area.

According to a conventional technique, weather information is based on providing all weather information with respect to all time points. For example, if sunny weather continues for about eight days, starting from today, a user interface in a form of providing all dates and all weathers corresponding to corresponding dates is provided.

However, people may be actually interested in the current weather and until when the current weather continues, that is, how long the current weather persists. For example, people may be more interested in whether it is going to snow or rain at the time of leaving work although it is sunny at the time of going to work and for another example, more interested in when it is going to stop snowing although it is snow a lot at the time of going to work. In such all cases, although the current weather continues for a long period of time, it is unnecessary to show weather information at all time points to users and a user may live everyday life very efficiently even if only information on the type of the current weather and until when the current weather continues and what kind of weather the current weather is to be changed is provided.

When viewed from this perspective, when weather information is provided to a user through a weather function object according to an embodiment of the present invention, very effective weather information may be delivered to a user through a very limited area.

That is, through the weather function object WFOB shown in FIG. 6A, a user may easily and intuitively obtain information on 1) the type of the current weather is “sunny,” 2) the current temperature is 10° C., 3) sunny weather continues for two days, and 4) it changes into cloudy weather after two days.

Similarly, through the weather function object WFOB shown in FIG. 6B, a user may easily and intuitively obtain information on 1) the type of the current weather is “sunny,” 2) sunny weather continues only for three hours, and 3) it is going to rain after three hours. If obtaining weather information through the weather function object WFOB shown in FIG. 6B right before going to work, as taking an umbrella before leaving home, a user may easily deal with a weather that is to change after three hours.

Hereinafter, a method of controlling a calendar including weather information is described according to an embodiment of the present invention.

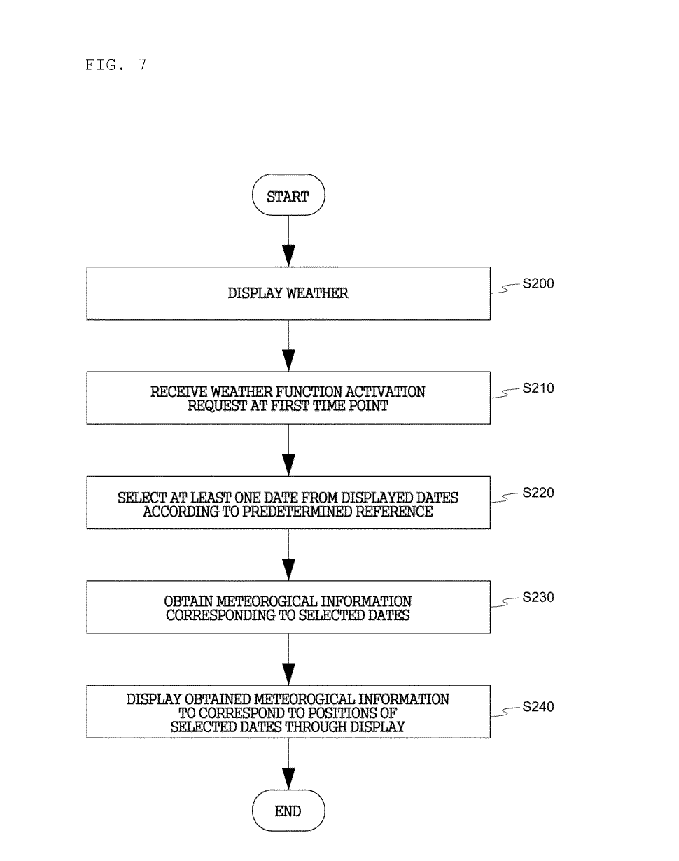

FIG. 7 is a flowchart illustrating a method of controlling a calendar including weather information according to an embodiment of the present invention.

Referring to FIG. 7, a method of controlling a calendar including weather information according to an embodiment of the present invention may include displaying a date through the display 142 of the electronic device 100 in operation S200, receiving a weather function activation request at a first time point in operation S210, selecting at least one date among the displayed dates according to a predetermined reference in operation S220, obtaining meteorological information corresponding to the selected dates in operation S230, and displaying the obtained weather information to correspond to the positions of the selected dates through the display 142 in operation S240.

The electronic device 100, as shown in FIG. 2, may display a date through the display 142 of the electronic device 100 in operation S200.

Then, the electronic device 100 may receive a weather function activation request at a first time point in operation S210.

The electronic device 100 may receive the weather function activation request from a user, Operating System (OS) of the electronic device 100, and/or another application installed on the electronic device 100.

The electronic device 100 may provide an object for activating a weather function among function objects provided in the third to fifth areas R3, R4, and R5 shown in FIG. 2 and based on a user's selection for this, receive the weather function activation request. That is, when a user touches an object for activating a weather function among the function objects or clicks it by using a mouse, the weather function of the electronic device 100 may be activated.

Moreover, the function object for activating the weather function may be the weather function object WFOB described with reference to FIG. 6. That is, the weather function object WFOB shown in FIG. 6 may be provided to one area of the main GUI shown in FIG. 2 and based on a user's selection for the weather function object WFOB may be activated. The weather function object WFOB may serve as a button for activating a function in addition to a function for providing information.

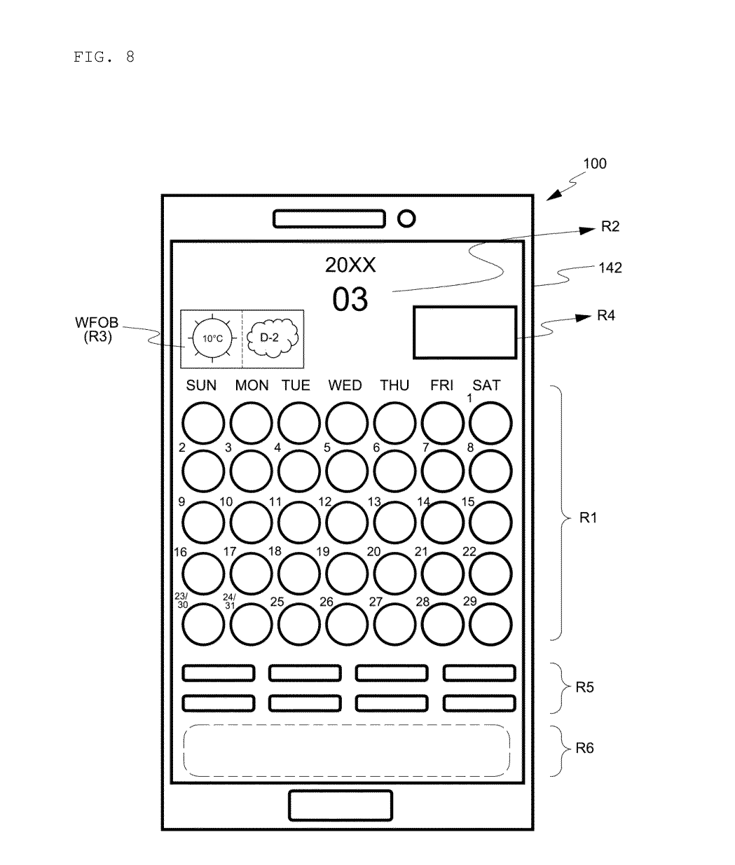

FIG. 8 is a view when a weather function object WFOB is included in the main GUI and displayed according to an embodiment of the present invention and as shown in FIG. 8, the weather function object WFOB shown in FIG. 6 may be provided in the third area R3 of FIG. 2 and the weather function object WFOB may serve as a function object for receiving a weather activation request from a user, which is described through operation S210. That is, when a user touches the weather function object WFOB shown in FIG. 8 or clicks it by using a mouse, the weather function may be activated.

Referring to FIG. 7 continuously, the electronic device 100 may select at least one date among the displayed dates according to a predetermined reference in operation S220.

For example, the electronic device 100 may select dates prior to the first time point among the displayed dates.

For another example, the electronic device 100 may select dates corresponding to the same type of weather as the time point of receiving the weather function activation request. That is, when a weather type is “sunny” at the time point of receiving the weather function activation request, the electronic device 100 may select a past date of which past weather type is “sunny” and furthermore select a future date that is predicted as “sunny” according to future weather forecast.

For another example, when the weather function object WFOB is used as the weather function activation button, the electronic device 100 may select the at least one date based on a user's touch position or a click position of a user on the weather function object WFOB. That is, when a user touches the first weather area WR1 included in the weather function object WFOB or clicks it by using a mouse, the electronic device 100 may select, as the at least one date, past dates and/or future dates having the same weather type as the first weather object WOB1 included in the first weather area WR1, and when a user touches the second weather area WR2 or clicks it by using a mouse, the electronic device 100 may select, as the at least one date, past dates and/or future dates having the same weather type as the second weather object WOB2 included in the second weather area WR2.

Then, the electronic device 100 may obtain meteorological information corresponding to the selected dates in operation S230. For example, the electronic device 100 may obtain information on at last one of temperature information, humidity information, rainfall information, precipitation probability information, wind velocity information, and wind direction information with respect to each of the at least one selected date.

At this point, the meteorological information may be a representative value corresponding to each of the selected dates. For example, if the information obtained in operation S230 is temperature information, the maximum value and/or the minimum value of a temperature of the corresponding date may be the representative value or the average value of the maximum value and the minimum value of a temperature of the corresponding date may be the representative value.

Then, the electronic device 100 may display the obtained meteorological information to correspond to the positions of the selected dates through the display 142 in operation S240. Moreover, in performing operation S240, the electronic device 100 may further display weather objects corresponding to the selected dates to correspond to the positions of the selected dates.

In displaying the obtained meteorological information and/or the weather object, the electronic device 100 may display the date object DOB described with reference to FIG. 2. That is, the obtained meteorological information and/or the weather object may be displayed on the date object DOB corresponding thereto.

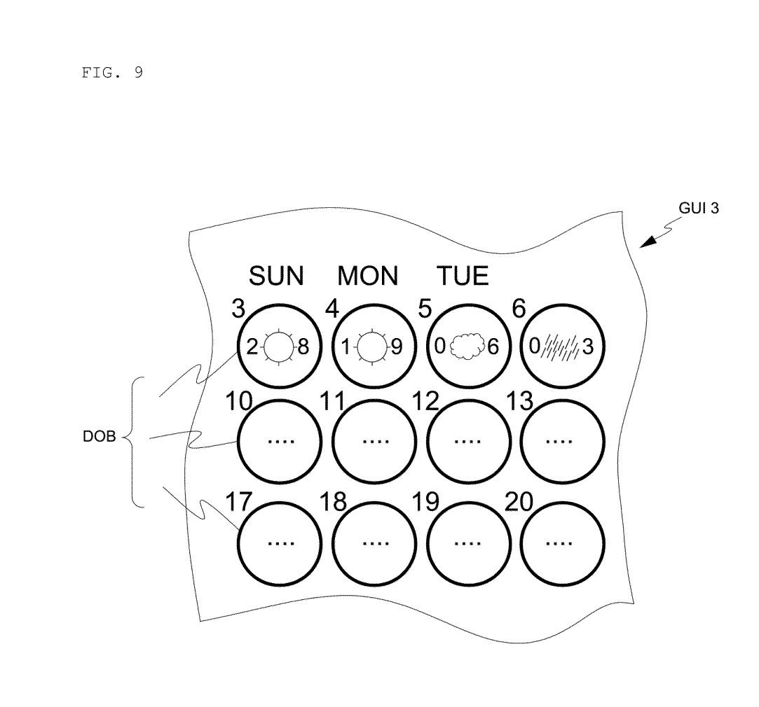

FIG. 9 is a view illustrating part of a GUI GUI3 provided after a weather function is activated according to an embodiment of the present invention.

Referring to FIG. 9, it is shown that according to the performance of operation S200 to operation S240, weather information (that is, weather type and/or meteorological information) corresponding to at least one selected date is displayed on a date object DOB. Especially, according to an embodiment of the present invention shown in FIG. 9, weather objects WOB corresponding to respective dates are displayed and simultaneously, the minimum value and the maximum value are obtained as a representative value of meteorological information of each date and displayed.

As shown in FIG. 9, when the weather information is displayed on the weather object DOB, a variety of information (for example, information on various schedules relating to a date corresponding to a date object) being displayed on the date object DOB may not be displayed any more. That is, when the weather function is activated, the weather information may be displayed on the date object DOB, instead of the information on the various schedules.

In such a case, although not shown in the drawing, when the weather function is deactivated again, instead of the weather function, schedules relating to the corresponding date may be displayed again on the date object DOB. Alternatively, when another function is activated, instead of displaying information corresponding to the weather function, information corresponding to the activated other function may be displayed on the date object DOB.

Above, a method of controlling a calendar including weather information is described according to an embodiment of the present invention. According to the above-mentioned method, a user of the electronic device 100 may easily obtain information on the weather of a past date and also information on the weather of a future date.

(4) Schedule Check Function #1 (Promise Function)

Hereinafter, one of other control methods for a calendar, that is, “schedule check function,” is described according to an embodiment of the present invention.

Hereinafter, the schedule check function, in some cases, may be referred to as “promise function.”

Additionally, “display property” means various properties that affect visual recognition in visually displaying information. For example, the display property may include display color, display brightness, blinking period, font (when information to be displayed is text), and size.

Furthermore, “A display property and B display property are different” may mean that at least one of information corresponding to the above-mentioned display property is different, and for example, even if display colors are different and other display properties are the same in relation to the A display property and the B display property, this may be described as “A display property and B display property are different”.

In order to set a schedule for a dinner with friends sometimes, each friend may check dates available for the dinner through a smartphone or a desktop computer. At this point, in order to check which date a schedule is empty, users may check schedules registered on each date one by one often by using an application provided from a smartphone or a desktop computer or installed. That is, when today is the first day, in order to set a meeting, sometimes, a user may be required to check each date to determine which date a dinner time is empty by checking each of schedules of the second day, the third day, and the fourth day.

Such an issue may occur identically when a business meeting schedule is set during business.

A method of controlling a calendar according to another embodiment of the present invention relates to removing such cumbersomeness and easily checking dates for setting a schedule.

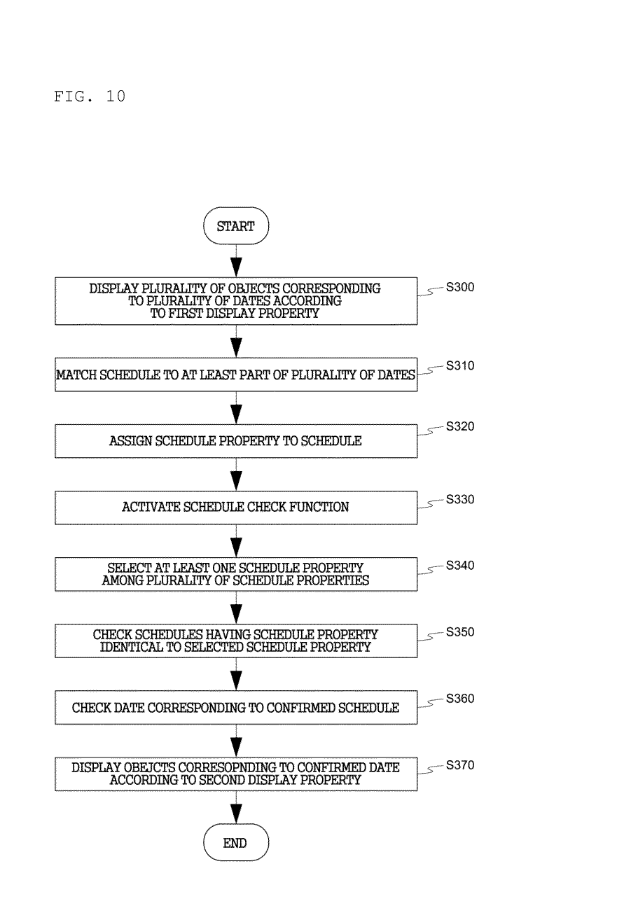

FIG. 10 is a flowchart illustrating a method of controlling a calendar according to another embodiment of the present invention.

Referring to FIG. 10, a method of controlling a calendar according to another embodiment of the present invention may include displaying a plurality of objects corresponding to a plurality of dates through the display 142 of the electronic device 100 according to a first display property in operation S300, matching a schedule to at least part of the plurality of dates in operation S310, assigning a schedule property to the schedule in operation S320, activating a schedule check function in operation S330, selecting at least one schedule property among a plurality of schedule properties after activating the schedule check function in operation S340, checking schedules having a schedule property identical to the checked schedule in operation S360, and displaying objects corresponding to the confirmed date according to a second display property in operation S370.

Hereinafter, each operation is described in detail.

The electronic device 100 may display a plurality of objects corresponding to a plurality of dates through the display 142 of the electronic device 100 according to a first display property in operation S300.

The plurality of objects may be the date objects DOB described with reference to FIG. 2. Moreover, according to the first display property, the electronic device 100 may display the display colors of the date objects DOB with black, the display brightness with a value set in OS of the electronic device 100, the blinking period without limitation (that is, a non-blinking state), and the font and size with a value set by OS of the electronic device 100 or a user.

Then, the electronic device 100 may match a schedule to at least part of the plurality of dates in operation S310.

That is, a user may register a schedule according to various input methods and a schedule input method according to the some embodiments of the present invention, and the electronic device 100 may match a registered schedule to a date corresponding thereto and store it according to a user's input, an OS request, and/or a result of another application.

Then, the electronic device 100 may assign a schedule property to the registered schedule in operation S320.

A method of assigning the schedule property to the registered schedule may vary.

First, the electronic device 100 may assign the schedule property in consideration of at least one of the start time point of the schedule and the end time point of the schedule.

For example, the schedule property may be selected from a category divided by each time slot such as morning, noon, afternoon, and evening and in such cases, the electronic device 100 may determine which category among the each time slot specific category the schedule property belongs in consideration of the start time point and/or the end time point of the registered schedule and assign one of time slot specific categories that the schedule belongs to the schedule as the schedule property.

More specifically, this is described with reference to the following [Table 1].

TABLE 1

| Category | Morning | Noon | Afternoon | Evening |
|---|---|---|---|---|
| Start time point | 08:00 | 12:00 | 13:00 | 18:00 |
| End time point | 12:00 | 13:00 | 18:00 | 22:00 |

As shown in [Table 1], when a time range of each time slot specific range is determined, in the case that the start time point of one schedule (hereinafter referred to as a schedule A) is 14:30 and the end time point is 16:00, a schedule property assigned to the schedule A is “afternoon”.

Meanwhile, when the start time point of another schedule (hereinafter referred to as a schedule B) is 16:00 and the end time point is 19:00, a schedule property assigned to the schedule B may be “afternoon” or “evening”. That is, two or more schedule properties may be assigned to one schedule.

The type of a time slot specific category and the start time point and the end time point of each category, shown in [Table 1], are exemplary and may be further simpler or more divided.

Moreover, the time slot specific category may be a value set in advance. A preset value for the time slot specific category may not be changed by a user but a category may be added to or deleted from the time slot specific category according to a setting of a user.

Second, the electronic device 100 may assign the schedule property in consideration of at least one of the schedule title and the schedule memo of the schedule.

The electronic device 100 may store keywords corresponding to each of a plurality of schedule property categories and when the schedule title and/or the schedule memo of a schedule are/is inputted by a user, check which one of the keywords is included in the schedule title and/or the schedule memo.

At this point, when one of the keywords is included in the schedule title and/or the schedule memo, the electronic device 100 may assign a schedule property corresponding to the included keyword as a schedule property of a corresponding schedule.

For example, when a first word and a second word are keywords corresponding to a first schedule property and a third word and a fourth word are keywords corresponding to a second schedule property, if the first word is included in the title of an inputted schedule, the electronic device 100 may assign the first schedule property as a schedule property of a corresponding schedule.

More specifically, this is described with reference to the following [Table 2].

TABLE 2

| Category | Meeting | Lunch | Dinner | Drink promise |
|---|---|---|---|---|
| Keyword | Conference, | Lunch | Dinner | Drink, soju, |
| | meeting, | | | beer |
| | business trip, | | | |
| | work outside | | | |

As shown in [Table 2], when a schedule property category specific keyword is matched, “XX company application meeting” is written in the schedule title of one schedule (hereinafter referred to as a schedule A), the electronic device 100 may recognize that “meeting” in the schedule title is a keyword corresponding to a “meeting” category and assign “meeting” as a schedule property for the schedule A.

Moreover, when “YY company” is written in the schedule title of another schedule (hereinafter referred to as a schedule B) and “business trip and lunch” is written in a schedule memo, the electronic device 100 may extract the keywords “business trip” and “lunch” from the content recorded in the schedule memo and assign the schedule properties “meeting” and “lunch” that respectively correspond to the extracted keywords as a schedule property for the schedule B. That is, two or more schedule properties may be assigned to one schedule.

The type of the category of the schedule property and the keyword corresponding to each category, shown in [Table 2], are exemplary.

Moreover, the category and the keyword shown in [Table 2] may be values set in advance and may not be changed by a user but a category may be added to or deleted from the category and the keyword by a resetting of a user and a keyword corresponding to a corresponding category may be also added or deleted.

Third, the schedule property of the schedule may be information received together when receiving information on the schedule from a user, the electronic device 100 may assign the information received from the user as the schedule property. That is, a field and/or an interface for separately receiving a schedule property may be provided through a UI (for example, the UI described with reference to FIG. 3) provided for registering a schedule by a user, and the electronic device 100 may assign schedule property information inputted from a user as the schedule property of the schedule in addition to a schedule title and/or a schedule memo through the interface.

As mentioned above, through various methods, the electronic device 100 may assign a schedule property to each registered schedule. Moreover, the assigned schedule property may be matched to information on the schedule and stored in the memory unit 130.

Then, the electronic device 100 may activate a schedule check function in operation S330.

For example, the electronic device 100 may activate the schedule check function at the request from OS installed on the electronic device 100, another application, and/or a user

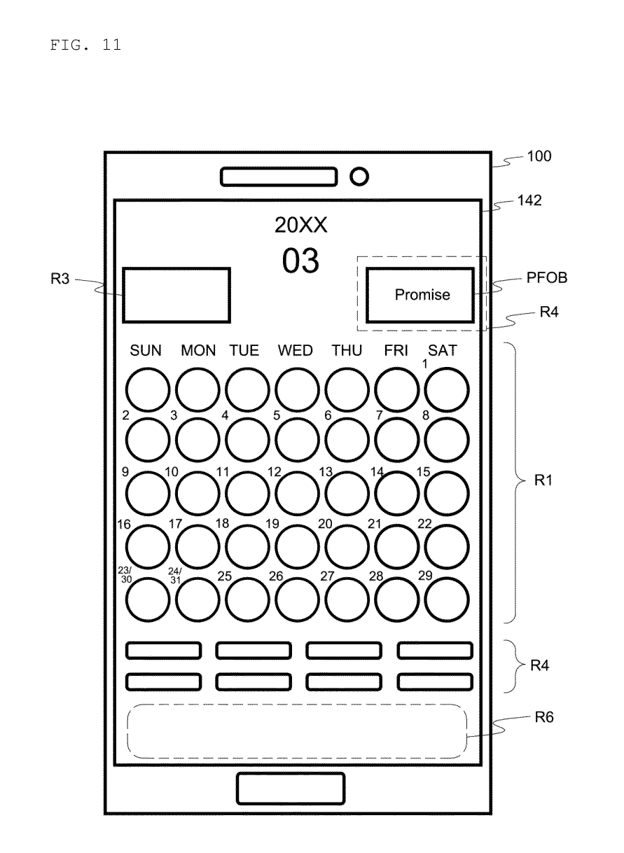

FIG. 11 is a view illustrating a schedule check function activation button according to an embodiment of the present invention.

As shown in FIG. 11, by touching a schedule check function activation button PFOB provided in a fourth area R4 of a main GUI or clicking it by using a mouse, a user may activate the schedule check function of the electronic device 100. Although it is shown in FIG. 11 that the schedule check function activation button PFOB is provided in the fourth area R4, the schedule check function activation button PFOB may be provided in a third area R3 or a fifth area R5.

Moreover, after the schedule check function is activated, the electronic device 100 may select at least one schedule property among a plurality of schedule properties in operation S340.

Operation S340 may be performed based on a selection input of a user.

For example, when the schedule check function is activated, the electronic device 100 may provide a UI for inputting/selecting the at least one schedule property. Accordingly, a user may input/select at least one schedule property through a UI provided through the electronic device 100 and the electronic device 100 may select at least one schedule property inputted/selected by a user.

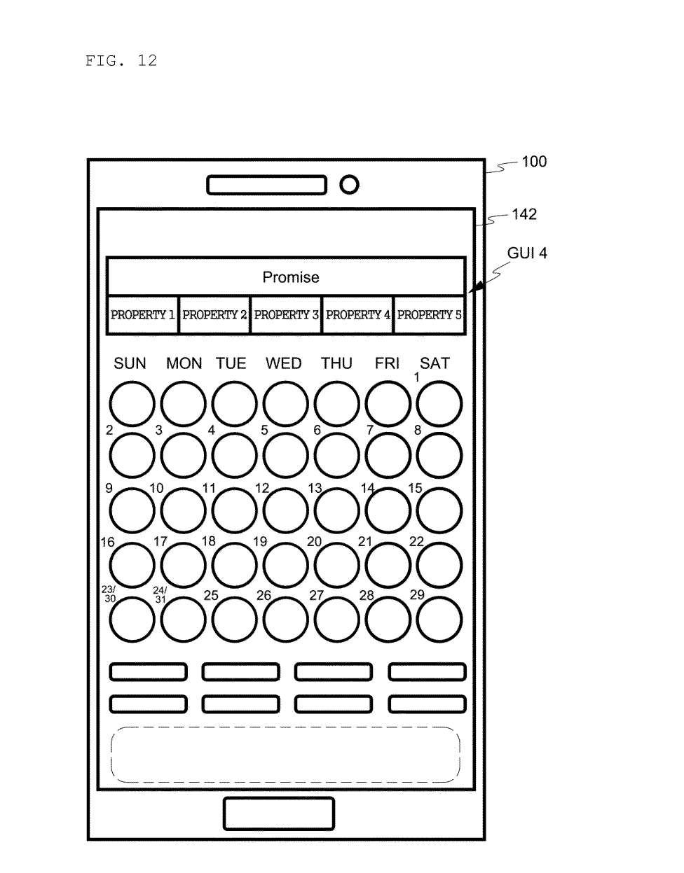

FIG. 12 is a view illustrating a GUI GUI4 provided for selecting a schedule property according to an embodiment of the present invention.

Referring to FIG. 12, it is shown that after the schedule check function activation button PFOB shown in FIG. 11 is selected, as expanding toward the third area R3 of FIG. 11, a category of schedule properties that are set is displayed together. In such a way, when a GUI GUI4 for selecting a schedule property provided by the electronic device 100 is provided, a user may select one or more schedule properties by touching a category of a schedule property to be selected or clicking it by using a mouse. The GUI GUI4 for selecting a schedule property shown in FIG. 12 is exemplary and it should be clarified that another form of a UI for selecting a schedule property may be provided.

Then, the electronic device 100 may check schedules having a schedule property identical to the selected schedule property in operation S350.

For example, when selecting “lunch” as a schedule property through the GUI GUI4 as shown in FIG. 12, a user may check schedules having a schedule property identical to the selected “lunch” schedule property.

Moreover, operation S350 may check schedules having a schedule property identical to the selected schedule property among schedules later than the time point for activating the schedule check function in operation S330 or the time point for selecting the schedule property in operation S340. That is, the schedules checked in operation S350 may be checked from future schedules than the time point for activating the schedule check function or the time point for selecting the schedule property.

Then, the electronic device 100 may check a date corresponding to the checked schedule in operation S360 and display objects corresponding to the confirmed date according to a second display property in operation S370. That is, when schedules having a schedule property identical to the selected schedule property are registered on the second, fifth, and eighth days, date objects corresponding to the second, fifth, and eighth days may be displayed according to the second display property.

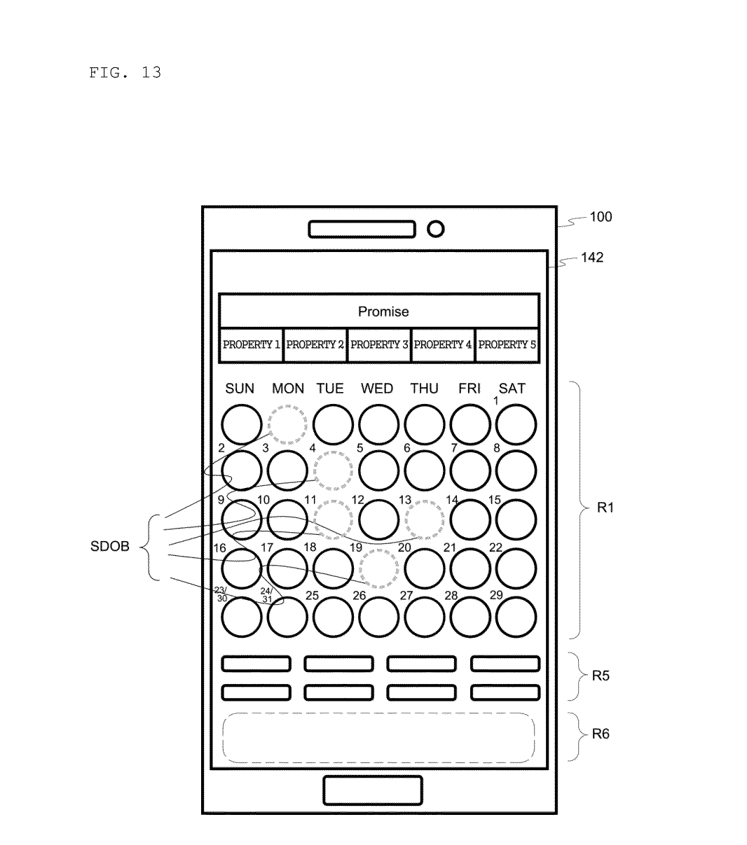

FIG. 13 is a view illustrating a screen for displaying a date object corresponding to a selected schedule property according to an embodiment of the present invention.

As shown in FIG. 13, the electronic device 100 may select date objects corresponding to a date checked through operation S350 to operation S360 and display selected date objects SDOB and other unselected date objects to be distinguished from each other. That is, when the original date object DOB is displayed according to the first display property, the selected date objects SDOB is displayed as the second display property different from the first display property and the other unselected objects are continuously displayed according to the first display property, so that the selected objects SDOB may be displayed to be distinguished from other objects.

In such a way, when operation S300 to operation S370 are performed, a user may easily check the date having a schedule property identical to the selected schedule property. That is, this allows a user to easily check that among date objects displayed as the first display property, date objects changed as the second display property and displayed are dates on which schedules having a schedule property identical to that selected by the user.

Meanwhile, in operation S370 according to the above-mentioned embodiment of the present invention, it is described that the display property of date objects corresponding to a confirmed date are displayed as the second display property. However, instead of displaying the display property of date objects corresponding to a confirmed date as the second display property, the display property of other date objects not corresponding to a confirmed date may be displayed as the second display property.

This is because when a date having a schedule property identical to a selected schedule property and a date having a different schedule property are displayed to be distinguished from each other, the object of the present invention may be achieved.

According to the above-mentioned embodiments of the present invention, although it is described a schedule property is selected after a schedule check function is activated, instead of selecting a schedule property, a time period selected from 24 hours (for example, a time range of 18:00 to 22:00) may be selected, dates including a schedule overlapping at least part of the selected time period may be checked, and the configured date (that is, a date on which a schedule overlapping a selected time period is registered) and other dates (that is, a date on which a schedule overlapping a selected time period is not registered) may be displayed to be distinguished from each other.

Meanwhile, in such a case, even if a schedule does not overlap a selected time period, when there are schedules adjacent before and after the selected time period, dates may be displayed in a similar manner to be distinguished by a setting of a user. For example, when a selected time period is 18:00 to 22:00, a date on which a schedule overlapping at least part of the selected time period is registered may be displayed as the second display property (for example, displayed with red color) and a date on which a schedule terminated 30 min before the selected time period is registered may be displayed as a third display property (for example, orange color) instead of the second display property.

Therefore, a user may easily know that another schedule overlapping the selected time period cannot be set on the date displayed as the second display property and when another schedule overlapping the selected time period is set on the date displayed as the third display property, it is adjacent to another schedule.

As mentioned above, in relation to another method of controlling a calendar according to an embodiment of the present invention, when setting a promise date and a promise time, a user may check a date and a time slot having no schedules by 1) selecting and activating a schedule check function and 2) performing an operation for selecting a schedule property to be checked.

That is, if a user attempt to set a dinner promise with someone, after activating a schedule check function and then selecting a “dinner” property, the user may easily check dates having dinner schedules, thereby very conveniently setting a promise date.

(4-1) Schedule Check Function #2 (Promise Together Function)

Hereinafter, a method of more easily setting a promise schedule (that is, a promise date and a promise time) in linkage with two or more electronic devices 100 used by two or more users by applying the schedule check function is described.

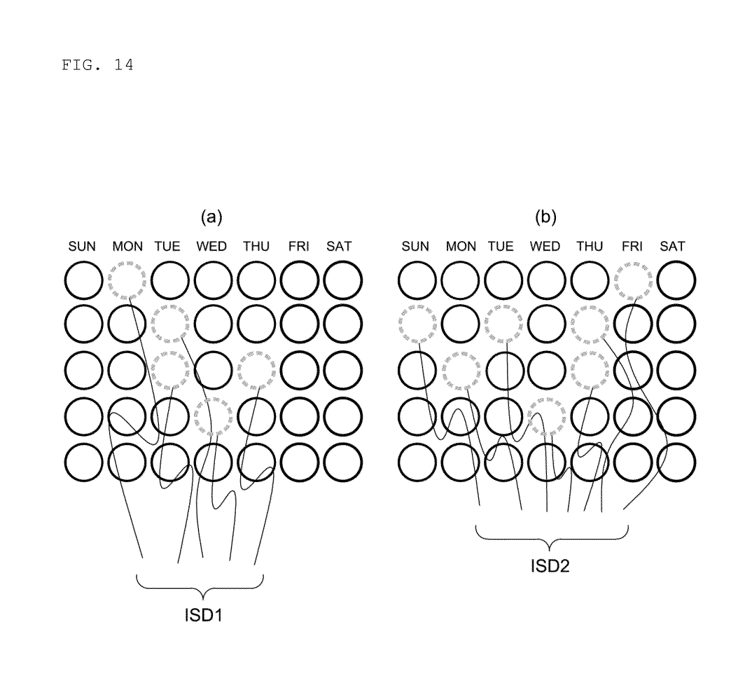

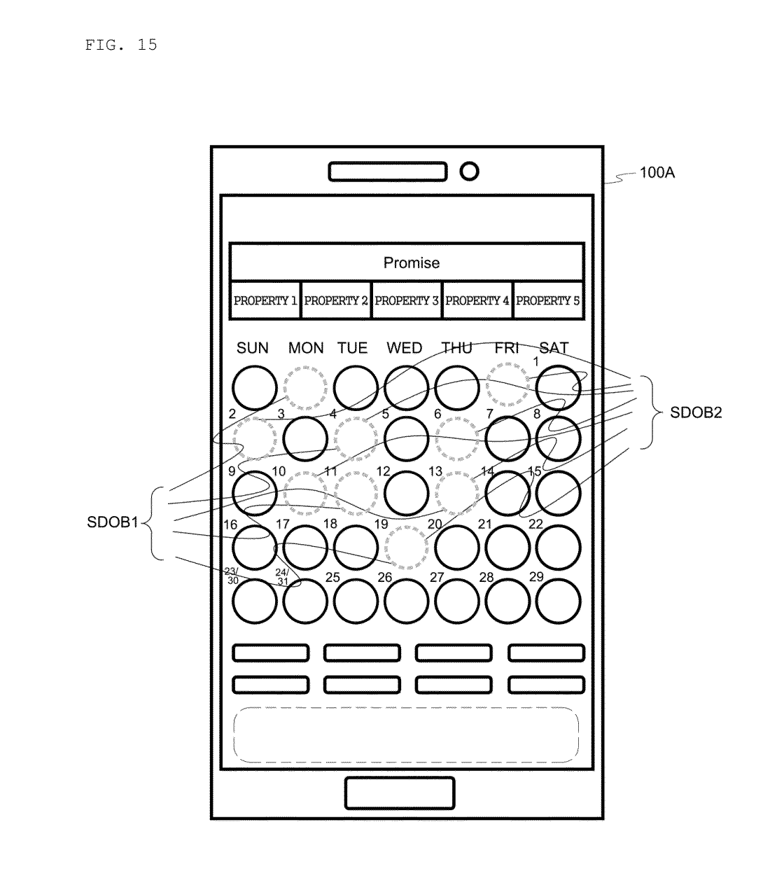

FIGS. 14 and 15 are views illustrating a method of controlling a calendar according to another embodiment of the present invention.

Hereinafter, for convenience of description, an electronic device of a first user is referred to as a first electronic device 100A and an electronic device of a second user is referred to as a second electronic device 100B.

First, the first electronic device 100A, similar to that described above, may activate a schedule check function and accordingly, select a schedule property and/or a time slot to be checked.

At this point, the first electronic device 100A may activate a “check schedule together” function at the request of the first user and at this point, receive a selection for another user (that is, the second user) who wants to check a schedule together.

That is, when the “check schedule together” function is activated, first electronic device 100A may provide a list of the user identification names registered as friends (for example, the names, nicknames, or mobile phone numbers of users registered as friends) and select at least one therefrom. Hereinafter, a case that one user (that is, only the second user) is selected is described as an example.

When receiving a selection for one user (that is, the second user), the first electronic device 100A may transmit a schedule check request to the second electronic device 100B that the selected user uses.

At this point, it is assumed that the first electronic device 100A and the second electronic device 100B are connected to each other through internet or wireless network.

The second electronic device 100B receiving the schedule check request from the first electronic device 100A may audibly or visually output a predetermined UI for notifying a user that the request is received from the first electronic device 100A and together this, receive a confirmation from the second user on whether to reply the schedule check request.

Additionally, the second electronic device 100B may obtain schedule property and/or time slot information, selected by the first user, from the first electronic device 100A and accordingly, perform operations S350 and S360 based on schedules that the second user registers in the second electronic device 100B. That is, the second electronic device 100B may check dates on which a schedule having a schedule property identical to that selected by the first user is registered or dates (hereinafter referred to as a second user check schedule date) on which a schedule overlapping the time slot selected by the first user is registered. For this, the second electronic device 100B may receive information on the selected schedule property and/or the selected time slot from the first electronic device 100A.

Then, the second electronic device 100B may transmit information on confirmed dates to the first electronic device 100A.

Meanwhile, the first electronic device 100A may also perform operation 350 and operation S360 separately from an operation of the second electronic device 100B. That is, the first electronic device 100A may check dates on which a schedule having a schedule property identical to that selected by the first user is registered or dates (hereinafter referred to as a first user check schedule date) on which a schedule overlapping the time slot selected by the first user is registered.

After the above-mentioned operations are performed, the first electronic device 100A may obtain all information on the first user check schedule date and the second user check schedule date. That is, the first electronic device 100A may obtain information on a schedule overlapping a time slot selected by the first user by checking the schedules of the first user and also obtain information on a schedule overlapping a time slot selected by the first user by checking the schedules of the second user.

After such an operation is performed, the first electronic device 100A may change the display properties of date objects corresponding to the first user check schedule date and the second user check schedule date. That is, information may be provided by reflecting both the first user's schedule and the second user's schedule.

That is, when a date (that is, the first user check schedule data ISD1) on which a schedule overlapping the selected time slot is registered is shown in FIG. 14A based on the first user's schedule and a date (that is, the second user check schedule data ISD2) on which a schedule overlapping the selected time slot is registered is shown in FIG. 14B based on the second user's schedule, the first electronic device 100A, as shown in FIG. 15, may display and distinguish date objects SDOB1 corresponding to the first user check schedule data ISD1 to be distinguished and also display and distinguish date objects SDOB2 corresponding to the second user check schedule data ISD2.

As mentioned above, in relation to a method of controlling a calendar according to another embodiment of the present invention, when setting a promise date and a promise date, a user may check a his/her date on which a schedule is empty at a corresponding time and check the other user's date on which a schedule is empty by checking the schedule of the other user who sets a promise together, so that a promise date and a time may be set more conveniently and easily.

(5) Schedule Move Function

Hereinafter, one of control methods for a calendar, that is, “schedule move function,” is described according to another embodiment of the present invention.

Often, a schedule that is determined already may be postponed due to unexpected circumstances. For example, although there is a dinner schedule with a friend in the evening of today, if a meeting with a client becomes longer unexpectedly, a user may not be able to keep the dinner promise with the friend. In such a case, the dinner promise schedule with a friend is postponed to another day.

Alternatively, although there is a schedule that is planned to be completed until 4:00 PM today, if another task occurs before a user completes a task that is planned to be completed, the scheduled task needs to be postponed to another day.

However, although an initially planned schedule is postponed for some reason, there is no way for a user to check whether a corresponding schedule is a postponed schedule.

Additionally, when a planned schedule is moved to another date, in order to change a corresponding schedule, it is cumbersome to check a date having no schedule by checking a schedule of another date one by one.

In relation to a method of controlling a calendar according to another embodiment of the present invention, when a schedule is changed (postponed) to another date, by allowing a user to easily check that a corresponding schedule is postponed, when another schedule needs to be postponed for schedule adjustment, provided is a method of preventing already postponed schedules from being postponed again. Furthermore, in relation to a method of controlling a calendar according to another embodiment of the present invention, provided is a method of recommending a date and/or a time slot for changing a schedule during schedule change.

Generally, a schedule may correspond to the start time point of the schedule, the end time point of the schedule, and information on a date on which the schedule is registered.

According to some embodiments of the present invention, the electronic device 100 may match information on the number of changes of a corresponding schedule to each schedule and store/manage it.

Hereinafter, for convenience of description, when the start time point of a schedule, the end time point of a schedule, and a date on which a schedule is registered are referred to as a collective sense, this may be called “schedule time property”.

Additionally, hereinafter, changing a schedule time property may mean changing at least one of a start time point, an end time point, and a date, that is, information included in the schedule time property.

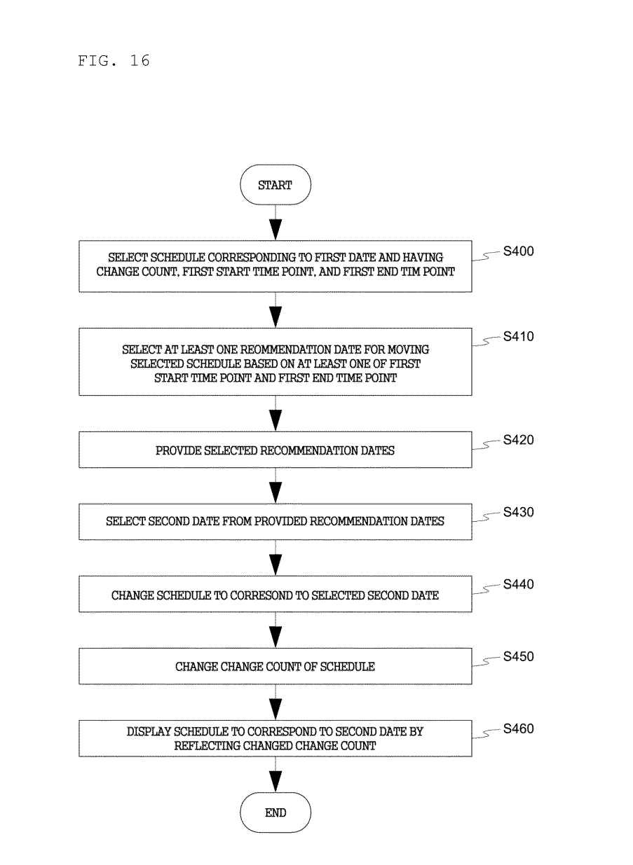

FIG. 16 is a flowchart illustrating a method of controlling a calendar according to another embodiment of the present invention.

Referring to FIG. 16, a method of controlling a calendar may include selecting a schedule that corresponds to a first date and has a change count, a first start time point, and a first end time point in operation S400, selecting at least one recommendation date to which the selected schedule is movable based on at least one of the first start time point and the first end time point in operation S410, providing the selected recommendation dates through the electronic device in operation S420, selecting a second date among the provided recommendation dates in operation S430, changing the schedule to correspond to the selected second date in operation S440, changing the change count of the schedule in operation S450, and displaying the schedule to correspond to the second date by reflecting the changed change count in operation S460.

Hereinafter, each operation is described in detail.

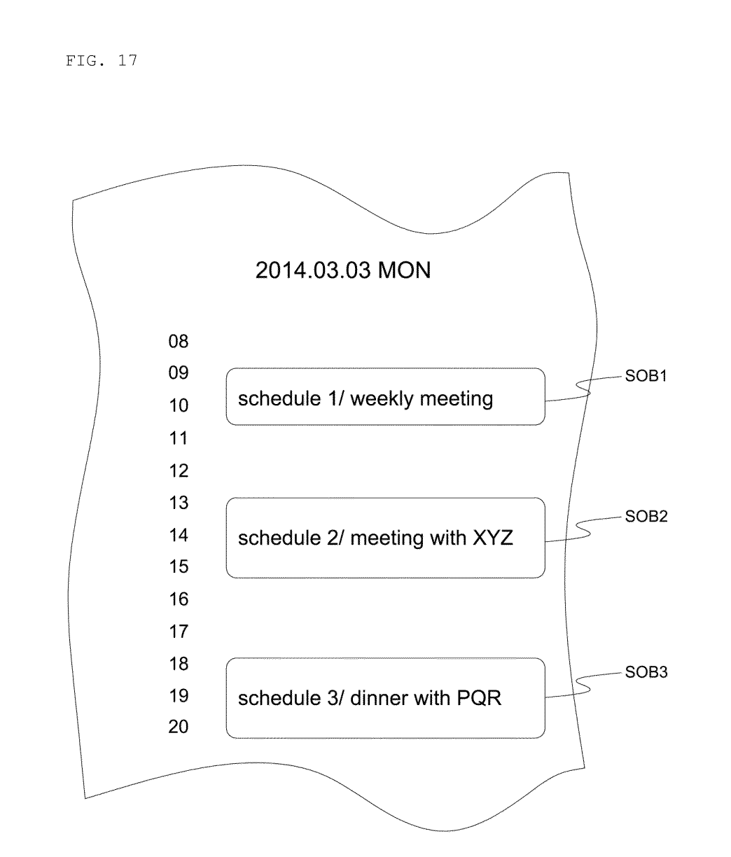

FIGS. 17 to 21 are views illustrating a method of controlling a calendar according to another embodiment of the present invention.

First, the electronic device 100 may select a schedule that corresponds to a first date and has a change count, a first start time point, and a first end time point in operation S400.

The electronic device 100 may provide a UI for receiving a schedule to be moved from a user and select the schedule according a user's input through the UI.

For example, when a date object DOB corresponding to a date on which a schedule to be moved by a user is registered is selected through the main GUI described with reference to FIG. 2, the electronic device 100 may display, to a user, schedules registered on the date corresponding to the selected date object DOB in more detail.

FIG. 17 is a view illustrating a UI for displaying a schedule registered on a selected date in detail. Referring to FIG. 17, schedule objects SOB1, SOB2, and SOB3 corresponding to schedules registered on a selected date are displayed to correspond to the start time point and the end time point of each schedule.

Through the UI shown in FIG. 17, a user may select a schedule object corresponding to a schedule to be moved among the displayed schedule objects SOB1, SOB2, and SOB3. However, the UI shown in FIG. 17 is just one example and may be provided in different forms in order to select a schedule to be moved.

Then, although not shown in the drawing, a user may perform a predetermined input for activating a schedule move function through the electronic device 100.

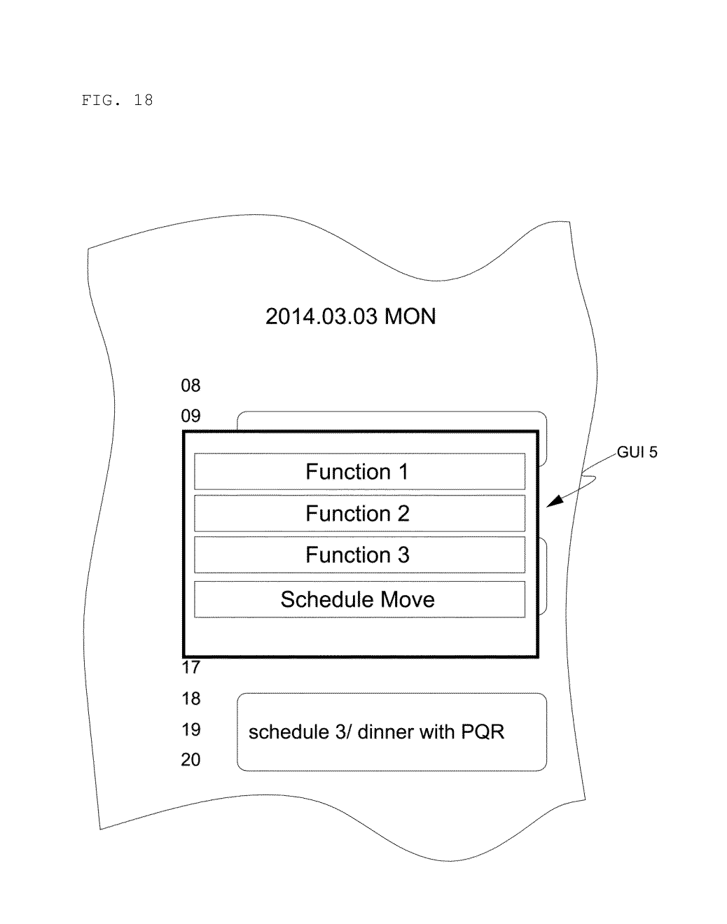

For example, as shown in FIG. 18, when a user selects the schedule object described with reference to FIG. 17, the electronic device 100 may provide a GUI GUI5 for selecting function being executed on a corresponding schedule and at this point, the user may activate a schedule move function by selecting the schedule move function.

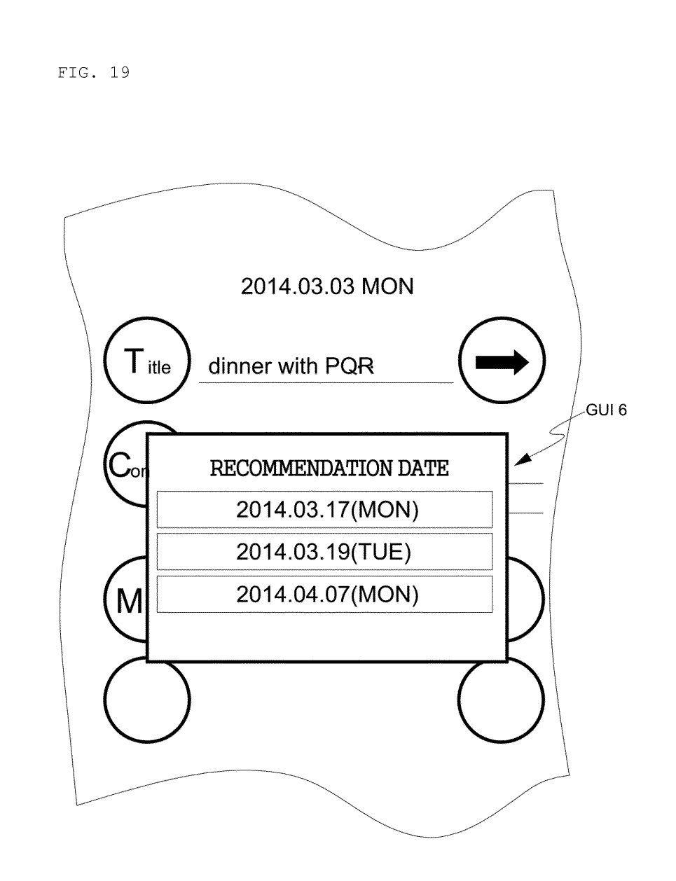

For another example, when a user selects the schedule object described with reference to FIG. 17, as shown in FIG. 19, the electronic device 100 may simultaneously provide more detailed content on a corresponding schedule and provide a UI including a function execution button corresponding to various functions executable on a corresponding schedule. At this point, as a user selects a button corresponding to a schedule move function among function execution buttons provided through the UI, the schedule move function may be activated.

The electronic device 100 may select at least one recommendation date on which the selected schedule is to be moved based on at least one of the first start time point and the first end time point in operation S410.

A method of selecting the recommendation dates may vary.

For example, the electronic device 100 may select, as the recommendation date, a date having no schedule that overlaps at least part of a range of the first start time point and the first end time point. That is, the electronic device 100 may select a date that another schedule is not registered at the start time point and the end time point of a schedule to be moved, and select it as a recommendation date. That is, when the schedule to be moved is a schedule progressing from 2:00 PM to 4:00 PM, the electronic device 100 may exclude a date having a schedule that overlaps a section from 2:00 PM to 4:00 PM and select a date having no schedule that overlaps the time section as the recommendation date.

For another example, in consideration of the first start time point and the first end time point, the electronic device 100 may select, as the recommendation date, a date having a blank schedule that is equal to or greater than a time range (that is, a difference between the first end time point and the first start time point) in which the schedule progresses. “Blank schedule” refers to a section where a schedule between a first schedule and a second schedule is not registered and that is, the electronic device 100 may select, as the recommendation date, a date having no schedule during a time that is the length of a schedule to be moved. For example, when the schedule to be moved is a schedule progressing from 2:00 PM to 4:00 PM, it is a schedule that it takes two hours and the electronic device may select a date having an empty schedule for more than two hours as the recommendation date. When a schedule is moved on a selected recommendation date in such a way, the start time point of the schedule before moving may be different from that of the schedule after moving and in the same manner, the end time point of the schedule before moving may be different from that of the schedule after moving. That is, a schedule before moving is a schedule starting at 2:00 PM and ending at 4:00 PM but the schedule after moving is a schedule starting at 4:00 PM and ending at 6:00 PM.

For another example, the electronic device 100 may select a date having the same day of the week as the first date as the recommendation date. That is, when the schedule before moving is registered on Monday, the electronic device 100 may select the recommendation date from the days of Monday.

Moreover, two or more various embodiments for selecting the above-mentioned recommendation date may be combined and applied.

Then, the electronic device 100 may provide the selected recommendation dates to a user through the display 142 of the electronic device 100 in operation S420.

The electronic device 100, as shown in FIG. 19, may provide a GUI GUI6 for displaying the selected recommendation data to a user in operation S410. Referring to FIG. 19, a plurality of recommendation dates are shown. The GUI GUI6 may perform a function for simply displaying a selected recommendation date and also perform a function for receiving at least one recommendation date (that is, a second date on which a schedule is to be moved) from a user through the GUI GUI6, as described below.

Then, the electronic device 100 may select the second date among the provided recommendation dates in operation S430. The electronic device 100 may select the second date according to a user's input as mentioned above. For this, the electronic device 100 may provide a proper UI.

After selecting the second date, the electronic device 100 may change the schedule to correspond to the selected second date in operation S440 and also, change the change count of the schedule in operation S450.

Additionally, the electronic device 100 may display the schedule to correspond to the second date by reflecting the changed change count in operation S460.

In operation S460, when a user uses a calendar according to the present invention, the electronic device 100 may display the schedules in order to distinguish and identify a schedule never postponed (that is, a schedule never changed), a schedule postponed once, and a schedule postponed N times.

For this, the electronic device 100 may check a display property previously specified to a change count in consideration of the change count corresponding to a schedule and display each schedule according to the confirmed display property. That is, as a schedule never postponed is displayed with white color, a schedule postponed once is displayed with orange color, and a schedule postponed two times is displayed with red color, when a user checks a schedule, they may be displayed in order for a user to intuitively check whether a corresponding schedule is changed.

Moreover, the electronic device 100 may display a change count corresponding to a schedule in a text form in addition to a schedule object SOB for displaying information on the schedule.

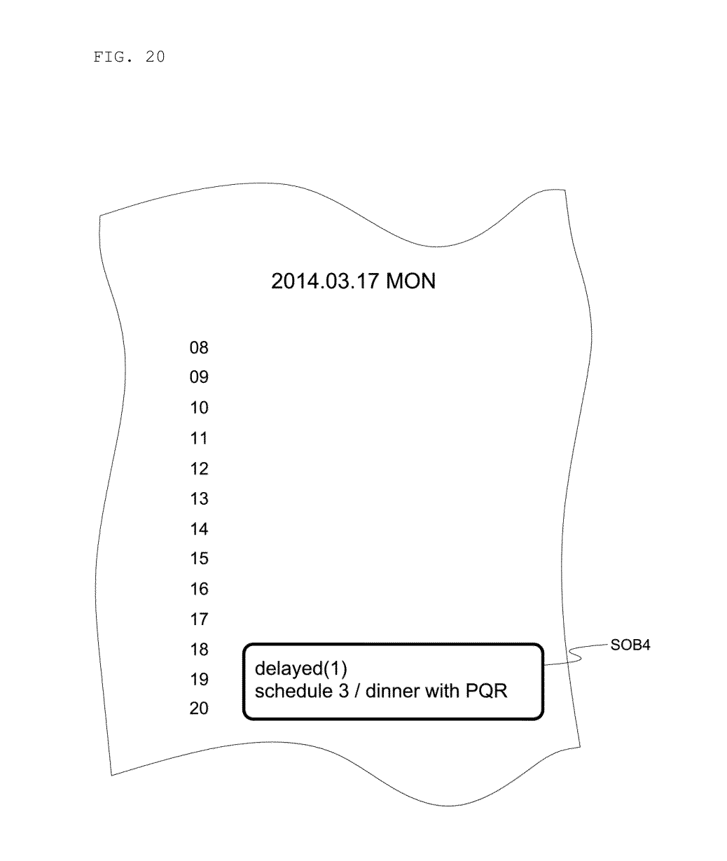

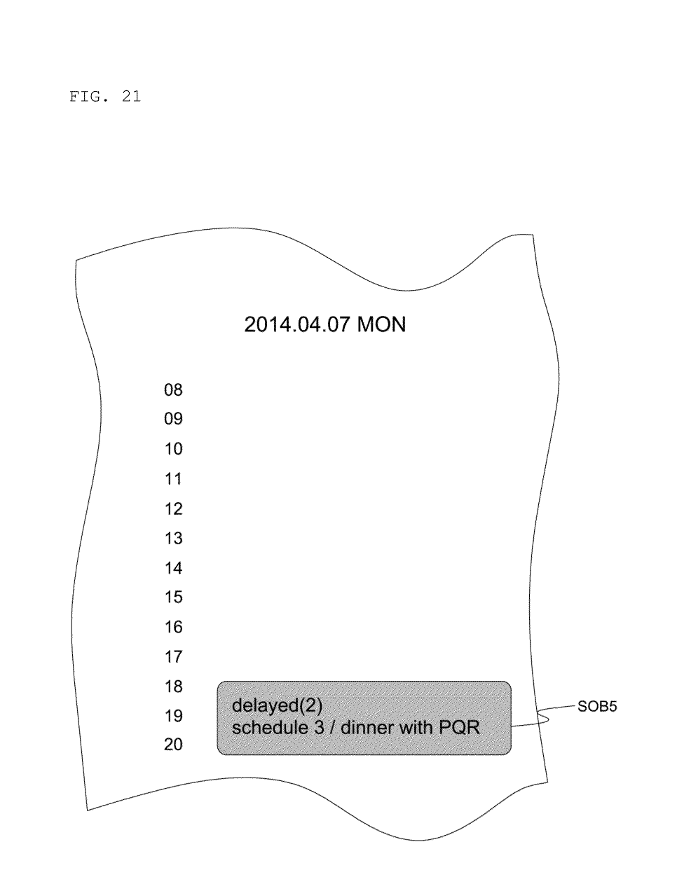

FIGS. 20 and 21 are views illustrating schedule objects SOB4 and SOB5 for representing a schedule moved on another date according to the performance of operation S400 to operation S460.

As shown in FIG. 20, as a count that a corresponding schedule is postponed is displayed in text on the schedule object SOB4, this may allow a user to know that a corresponding schedule is postponed once and as shown in FIG. 21, as a count that a corresponding schedule is postponed is displayed in text on the schedule object SOB5 and simultaneously the color of the schedule object SOB 5 is changed into another color and displayed, this allows a user to clearly know that a corresponding schedule is postponed twice.

Moreover, although not shown in the drawing, in selecting a recommendation date for moving a schedule, in consideration of the start time point and/or the end time point of the schedule for simply moving it as well as position information corresponding to a corresponding schedule, the electronic device 100 may select the recommendation date.

It is assumed that a place corresponding to a schedule to be moved is an A place and a time required for the schedule is two hours. At this point, when two hours are empty on the first date but a place corresponding to a schedule registered before or after the empty hours is a B place, a moving time from the A place to the B place may be considered for selecting the recommendation date. That is, when it is expected that a time required for moving from the A place to the B place is one hour, the electronic device 100 may not select the first date as the recommendation date. The reason is that when the schedule to be moved is moved on the first date, a user does not successfully participate on time in both the schedule to be moved (it is assumed after the schedule is moved) and another schedule already registered on the first date.

Alternatively, in consideration of a place corresponding to a schedule to be moved, the electronic device 100 may search for a date on which a schedule corresponding to the same place as the above is registered and consider the found date as a recommendation date preferentially. That is, when a time spare for a schedule to be moved exists on a date on which a schedule of the same place as the schedule to be moved, the electronic device 100 may select a corresponding date as the recommendation date preferentially. In relation to a method of controlling a calendar according to another embodiment of the present invention, when a user wants to postpone (or change) a date of a schedule, the method allows the user to change the schedule by using an automatically recommended recommendation date, so that the schedule may be changed more easily.

Furthermore, after the schedule is changed, the changed schedule and unchanged schedules are displayed distinguishingly, and how many times the changed schedule is changed is notified to a user. Thus, when the schedule needs to be adjusted, a user may be induced naturally not to postpone the changed schedules again. Accordingly, a user gets help to manage schedules more efficiently.

(6) Advertisement Interworking Function

Hereinafter, one of control methods for a calendar, that is, “advertisement interworking function,” is described according to another embodiment of the present invention.

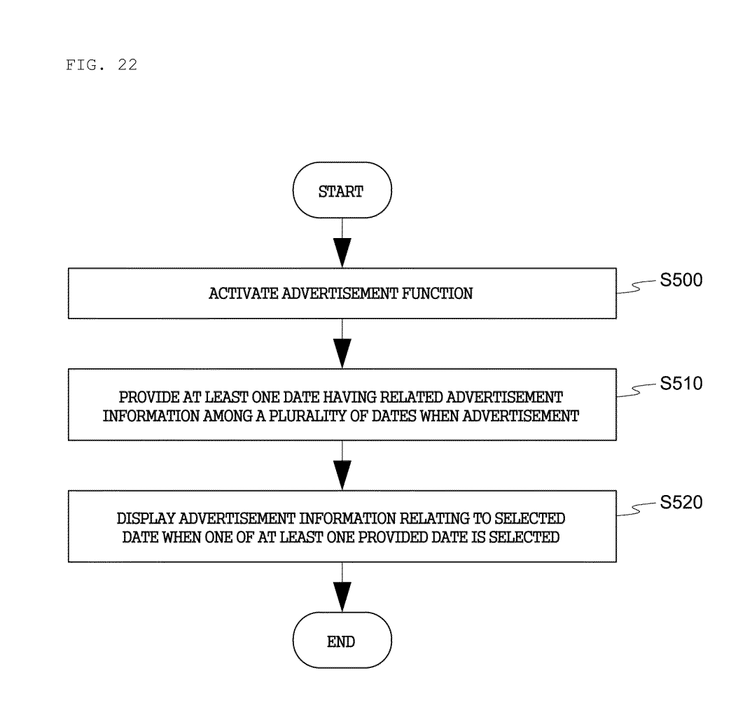

FIG. 22 is a flowchart illustrating a method of controlling a calendar according to another embodiment of the present invention.

Referring to FIG. 22, a method of controlling a calendar according to another embodiment of the present invention may include activating an advertisement function in operation S500, providing at least one date including related advertisement information among a plurality of dates once the advertisement function is activated in operation S510, and displaying the advertisement information relating to the selected date when one of the at least one provided date is selected in operation S520.

Hereinafter, each operation is described in detail.

The electronic device 100 may activate an advertisement function in operation S500.

The electronic device 100 may activate the advertisement function at the request of a user or at the request of OS of the electronic device 100 and/or another application installed on the electronic device 100.

In order to activate the advertisement function at the request of a user, the electronic device 100 may provide an advertisement function activation button in the third to fifth areas R3, R4, and R5 described with reference to FIG. 2.

That is, according to a conventional technique, by using a method of exposing advertisement information at all times to a main screen for displaying a calendar, unnecessary advertisement is compulsorily provided to a user, so that users feel inconvenient. However, according to the present invention, by allowing a user to activate an advertisement function and providing advertisement information only when the advertisement function is activated, users allow only necessary customized advertisements.

When the advertisement function is activated, the electronic device 100 may provide at least one date having related advertisement information among a plurality of dates in operation S510.

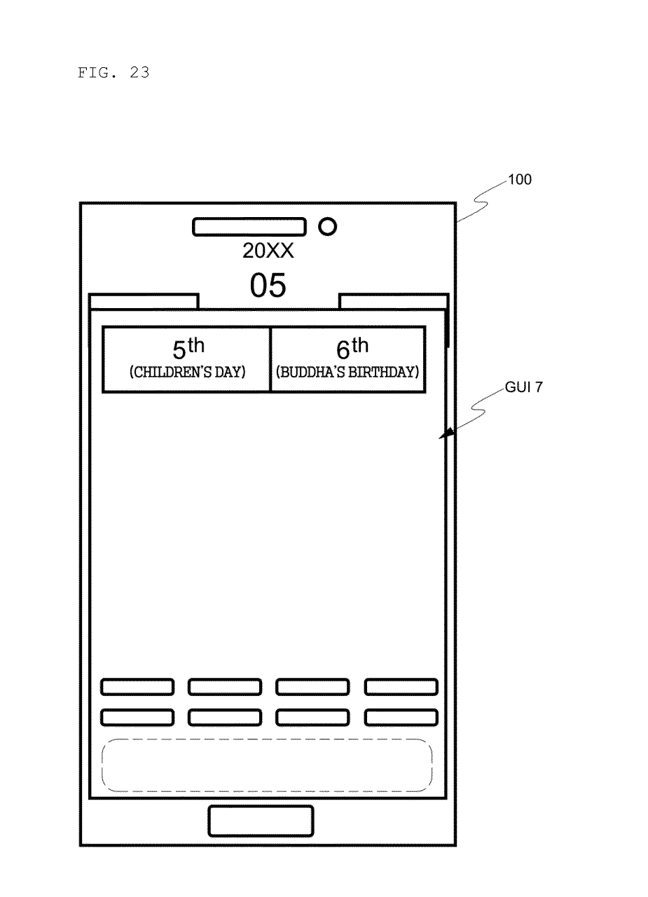

FIGS. 23 to 28 are views illustrating a UI for providing at least one date having advertisement information depending on a control method for a calendar according to another embodiment of the present invention.

Referring to FIG. 23, when an advertisement function is activated, the electronic device 100 may display a GUI GUI7 for displaying, to a user, at east one date corresponding to advertisement information. The GUI GUI7 shown in FIG. 23 is provided on a layer separated from the main GUI shown in FIG. 2 and display information on a date corresponding to advertisement information together. Additionally, additional information on the date corresponding to the advertisement information is further displayed. For example, the additional information may be for displaying “topic (theme)” of the advertisement information corresponding to each date. That is, the additional information “children's day” is displayed on May 5 and this represents that advertisement information corresponding to May 5 corresponds to the theme of “children's day.”

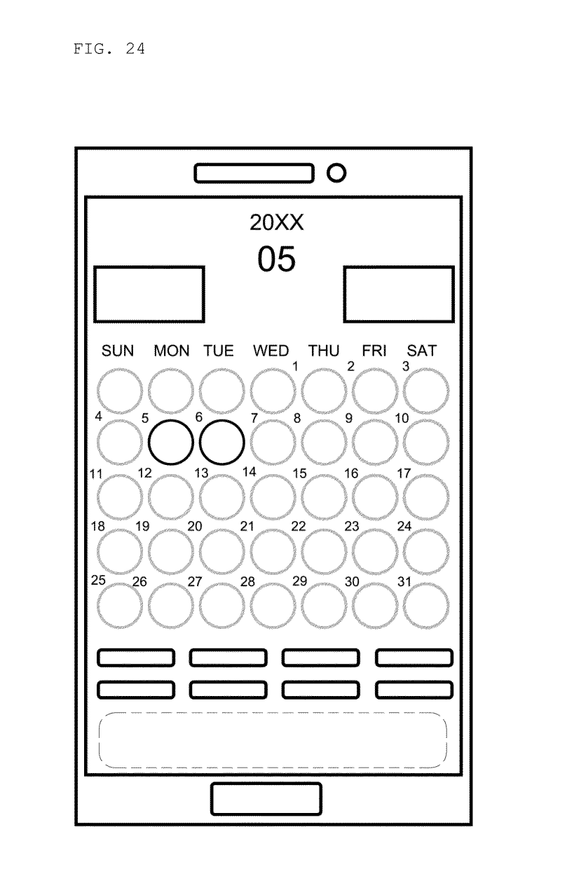

Unlike the description of FIG. 23, FIG. 24 illustrates a method of displaying a date corresponding to advertisement information on a main GUI to a user instead of providing an additional UI. Referring to FIG. 24, when an advertisement function is activated, the electronic device 100 may highlight and display only a date corresponding to advertisement information among a plurality of date objects included in the main GUI described with reference to FIG. 2. That is, the properties of date objects of a date corresponding to advertisement information and date objects of a date not corresponding to the advertisement information are displayed to be different from each other. For example, the electronic device 100 may blurredly display objects of a date not corresponding to advertisement information and boldly display objects of a date corresponding to the advertisement information.

A user may select a date to see corresponding advertisement information in detail through the UI shown in FIGS. 23 and 24.

Then, when one of the at least one provided date is selected, the electronic device 100 may display the advertisement information relating to the selected date in operation S520.

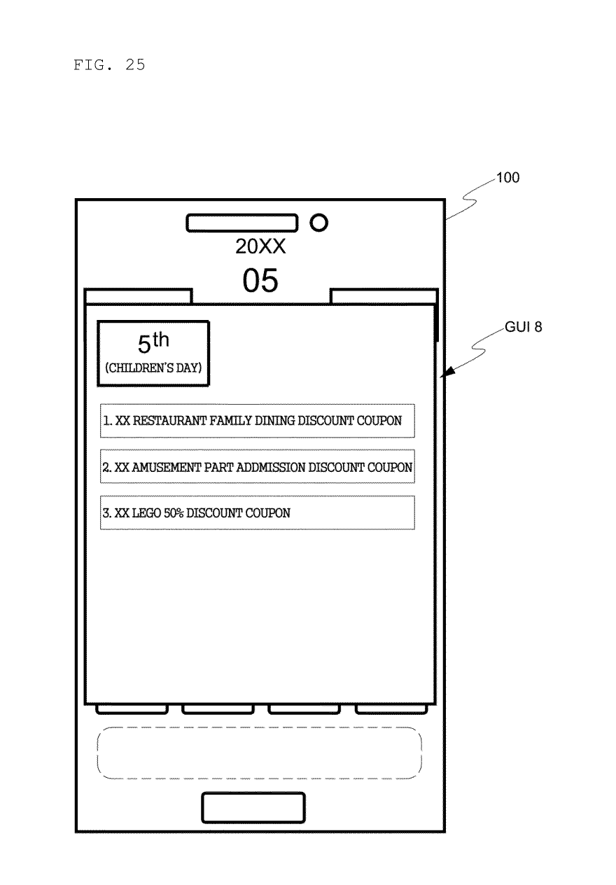

For example, the electronic device 100, as shown in FIG. 25, may display advertisement information corresponding to the selected date through a GUI GUI8.

At this point, a priority for displaying advertisement information corresponding to the selected date may be selected.

The priority may be a region.

For example, a user may select a specific region to see advertisement information and in relation to the advertisement information, information relating to the region may be displayed first and advertisement information not relating to the region may be displayed later.

For another example, the electronic device 100 may check the current location of the electronic device 100 and assign a priority for displaying advertisement information according to the current location.

The priority may be a category.

For example, a user may select one of categories having classified advertisement information and the advertisement information on the selected category may be displayed first. That is, when a “dining out” category is selected, advertisement information relating to dining out may be displayed first and when a “travel” category is selected, advertisement information relating to travel may be displayed first.

A user may select specific advertisement information among a plurality of advertisement information through the GUI GUI8 and the electronic device 100 may provide various additional functions for the selected advertisement information.

The various additional functions are described.

When one advertisement information is selected from the plurality of advertisement information by a user, the electronic device 100 may perform a subsequent procedure for providing additional information on the advertisement information. For example, if there is a website relating to the selected advertisement information, by connecting to website and displaying it, a user may obtain additional information on advertisement information.

Alternatively, when one advertisement information is selected from the plurality of advertisement information by a user, the electronic device 100 may perform a subsequent procedure for making a payment for goods and/or service relating to the advertisement information. That is, the electronic device 100 may provide a purchase interface in order to make a payment for the goods and/or service.

When a purchase procedure is completed through the purchase interface, the electronic device 100 may automatically register information on the goods and/or service in a schedule. For example, when goods and/or service are purchased through advertisement information corresponding to May 5, content on the purchased goods and/or service may be registered in correspondence to May 5. The registered goods and/or service may be displayed in correspondence to a date object DOB displayed on the main GUI described with reference to FIG. 2 and thus, a user may not forget goods and/or service that the user purchases.

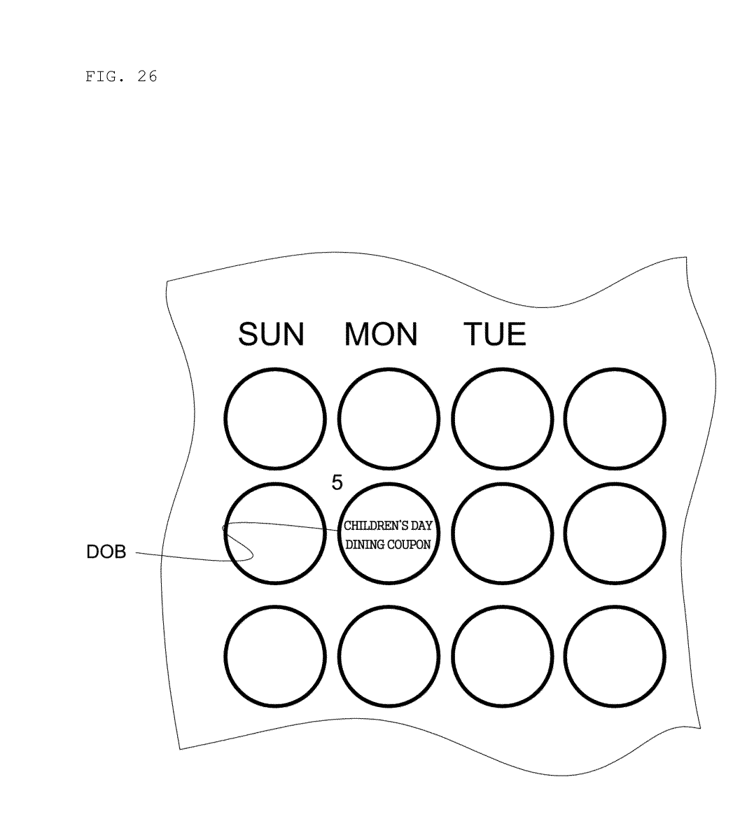

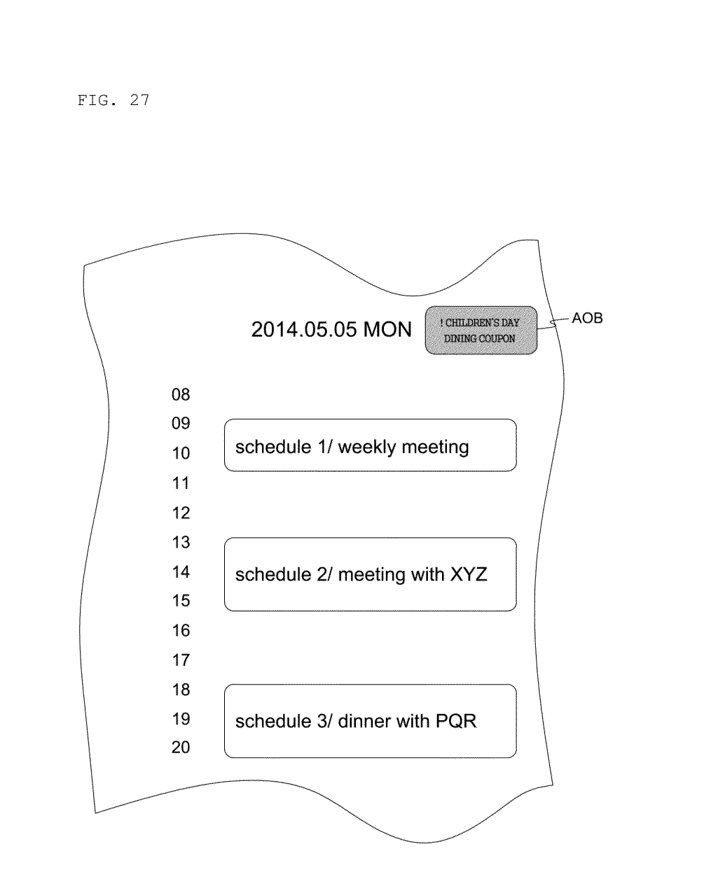

Alternatively, when at least one advertisement information is selected from the plurality of advertisement information by a user, the electronic device 100 may store content on the selected advertisement information in correspondence to the date. Additionally, the electronic device 100, as shown in FIGS. 26 and 27, may display content of advertisement information stored in correspondence to a date through a date object DOB corresponding to the date and/or a schedule display screen corresponding to a corresponding date. That is, even if an advertisement function is not activated, as a user uses a calendar according to the present invention, the user may check advertisement information selected by the user in addition to a schedule registered on a date. At this point, as shown in FIG. 27, when a user selects an object AOB corresponding to the selected advertisement information again, without additional advertisement function activation procedure, the electronic device 100 may obtain specific information linked to the advertisement information and display it to a user.

Moreover, as mentioned above, when at least one advertisement information is registered by a user's selection, the electronic device 100 may notify the user that there is advertisement information registered on the date at a predetermined time point before the date (for example, May 5 arrives).

Through this, a user may easily register interesting advertisement information to a calendar and easily access the advertisement information without activating an advertisement function for the registered advertisement information. Furthermore, a notification is provided to the user again before a date corresponding to corresponding advertisement information arrives, so that the user may determined whether to make a purchases on advertisement information again.

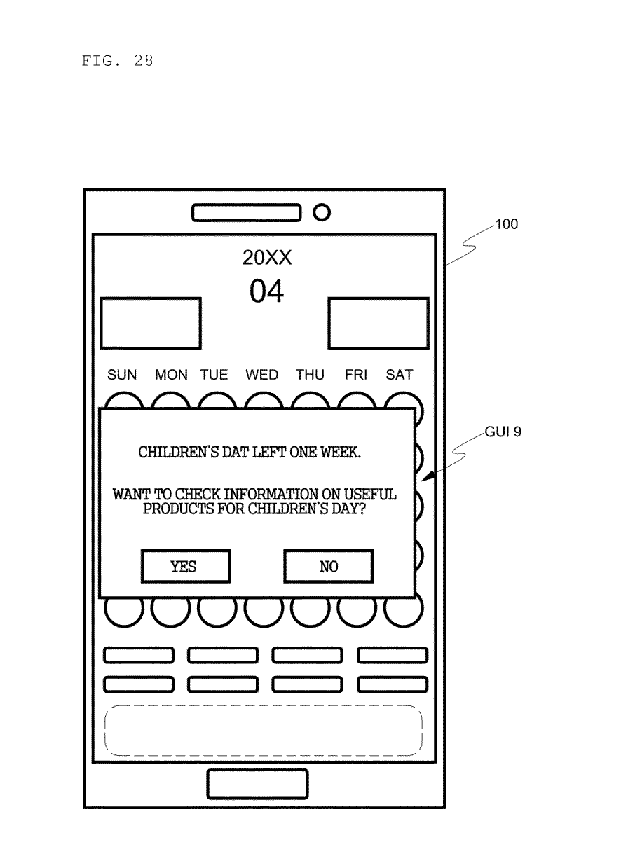

As shown in FIG. 28, the electronic device may provide a UI for notifying a user that advertisement information corresponds to a corresponding date at a predetermined time point before a date corresponding to advertisement information arrives.

For example, when advertisement information is registered on May 5, as shown in FIG. 28, the electronic device may display a GUI GUI9 for notifying that advertisement information is registered on May 5, on April 28 that is a week (that is, a predetermined time point) before May 5 arrives.

The notification may include information on a date corresponding to the advertisement information and a topic (theme) of the corresponding advertisement information.

At this point, if a user wants to see advertisement information registered on May 5 continuously, the electronic device 100 may omit operation S500 and operation S510 and perform operation S520, so that it may provide more detailed advertisement information to the user and perform an additional function according thereto.

(6) Advertisement Interworking Function #2

Hereinafter, one of control methods for a calendar, that is, “advertisement interworking function,” is described according to another embodiment of the present invention.

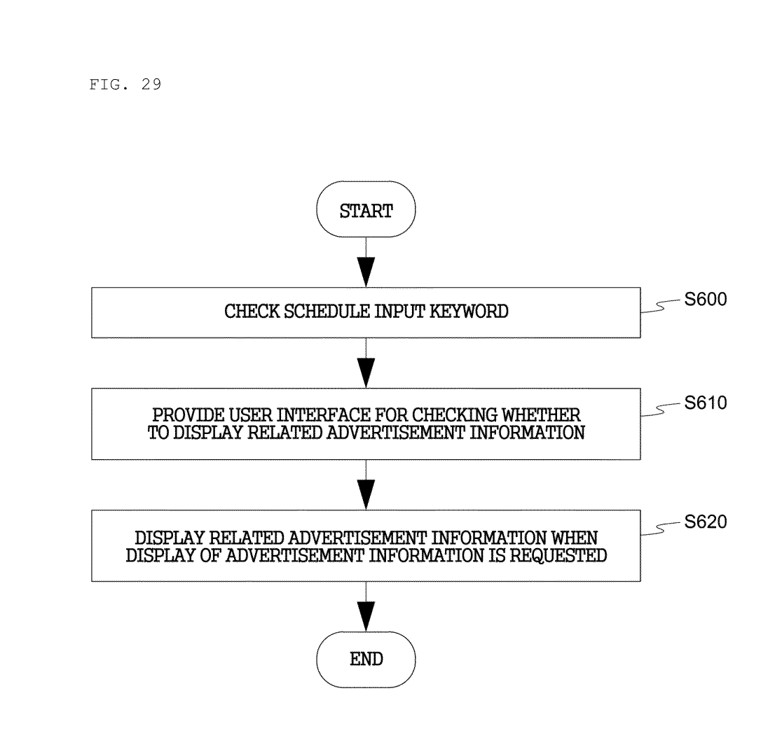

FIG. 29 is a flowchart illustrating a method of controlling a calendar according to another embodiment of the present invention.

Referring to FIG. 29, a method of controlling a calendar according to another embodiment of the present invention may include checking a schedule input keyword in operation S600, providing a UI for checking whether to display related advertisement information if there is advertisement information relating to the schedule input keyword in operation S610, and displaying the related advertisement information when the display of the related advertisement information is requested through the provided UI in operation S620.

Hereinafter, each operation is described in detail.

The electronic device 100 may check a schedule input keyword in operation S600.

While the schedule title and/or schedule memo of a schedule are/is being inputted, the electronic device 100 may monitor an inputted text. The electronic device 100 may monitor whether a keyword linked with predetermined advertisement information is included in the inputted text. For example, if there is advertisement information relating to children's day presents or children's day travel products, “children” and/or “present” may be linked as a keyword relating to the advertisement information and in such a case, the electronic device 100 may check whether the linked keyword is included in the schedule title or the schedule memo inputted by a user. That is, when a user inputs “play with son on children's day” or “buy son's present” to a schedule title and/or a schedule title, the electronic device 100 may determine that the keyword “children” and the keyword “present” are included in corresponding content.

Moreover, since advertisement information may be in plurality and keywords linked to each corresponding advertisement information may exist, when receiving content of a schedule title and/or a schedule memo from a user, the electronic device 100 may check whether a corresponding keyword is included in an inputted text, with respect to a plurality of keywords that are respectively linked with a plurality of advertisement information.

Then, if there is advertisement information relating to the schedule input keyword, the electronic device 100 may provide a UI for checking whether to display the related advertisement information in operation S610. That is, when a linked keyword is included in an inputted text in operation S600, the electronic device 100 may determine that there is advertisement information relating to a schedule input keyword and if it is determined that there is related advertisement information, the electronic device 100 may provide a UI for receiving a confirmation on whether to display the related advertisement information from a user.

The UI may be provided in various manners.

For example, if is determined that a keyword linked to advertisement information is included in a schedule title or a schedule memo inputted by a user, the electronic device 100 may display a predetermined object for notifying that advertisement information is in one area of the display 142. That is, the electronic device 100 may display a predetermined object having the text “AD” or “advertisement” or a symbol corresponding thereto in the one area of the display 142. The predetermined object may be displayed added with visual effects such as blinking for allowing a user to easily recognize it. At this point, if a user touches the predetermined object or clicks it by using a mouse, operation S620 described below may be executed.

At this point, the predetermined object may be displayed in the one area of the display 142 for only a predetermined time and after the predetermined time, not displayed any more.

For another example, if is determined that a keyword linked to advertisement information is included in a schedule title or a schedule memo inputted by a user, the electronic device 100 may display an alarm window in one area of the display 142. A text for notifying that there is advertisement information relating to the inputted text may be included and displayed in the alarm window and moreover, the alarm window may include predetermined buttons (for example, an “yes” or “no” button) for receiving a selection on whether to display related advertisement information from a user. When a user requests the display of related advertisement information through the predetermined buttons, operation S620 described below may be executed.

Then, when the display of related advertisement information is requested through the provided user interface, the electronic device 100 may display the related advertisement information on the display unit 142 in operation S620.

In operation S620, advertisement information may be displayed in various forms on the display unit 142 and for example, as shown in FIG. 25, related advertisement information may be displayed in a list form and more specific advertisement information may be displayed according to an additional selection of a user on a corresponding list.

Additionally, according to the above-mentioned embodiment of the present invention, advertisement information, as mentioned above, may include additional memo information that a user notes on the electronic device 100.

For example, a user may record information on specific places (for example, attractions, famous restaurants, and so on) and specific products (for example, travel products, gift products, and so on) through the electronic device 100. The electronic device 100 assigns a keyword for the recording from the user's recording and based on the assigned keyword, monitors whether the keyword assigned to the user's recording is included in a schedule title or a schedule memory inputted by a user in performing operation S610. Accordingly, it may be displayed that there is the user recording related to the inputted schedule title or schedule memo. Accordingly, when there is a user request on the display of related user recording, the electronic device 100 may display information that a user records on the display unit 142 in operation S620.

(7) Missed Call Schedule Registration Function

Hereinafter, one of control methods for a calendar, that is “missed call schedule registration function,” is described according to another embodiment of the present invention.

Hereinafter, “call reception” refers to receiving an incoming call signal by a mobile communication terminal such as a smartphone and receiving a signal for voice call received through Voice over Internet Protocol (VoIP) by an electronic device connected to internet such as a desktop computer, a smartphone, and/or a tablet.

Additionally, “missed call” refers to both “call during absence” that does not make a response to “call reception” and a call that rejects a response for “call reception.”

Often, when a call is received, a user may not answer the call while doing another task or attending a meeting. In the case of not answering a call, a user may not respond to an incoming call at all, or may reject an incoming call signal by using a “reject” function, or may use a method of sending a text message that includes a phrase for notifying an call reception unavailable situation to the other party of the call while rejecting a call signal.

However, when not answering or rejecting such an incoming call, a user may forget to call the other party again.

By a method of controlling a calendar according to another embodiment of the present invention, it is possible to solve the above-mentioned issue.

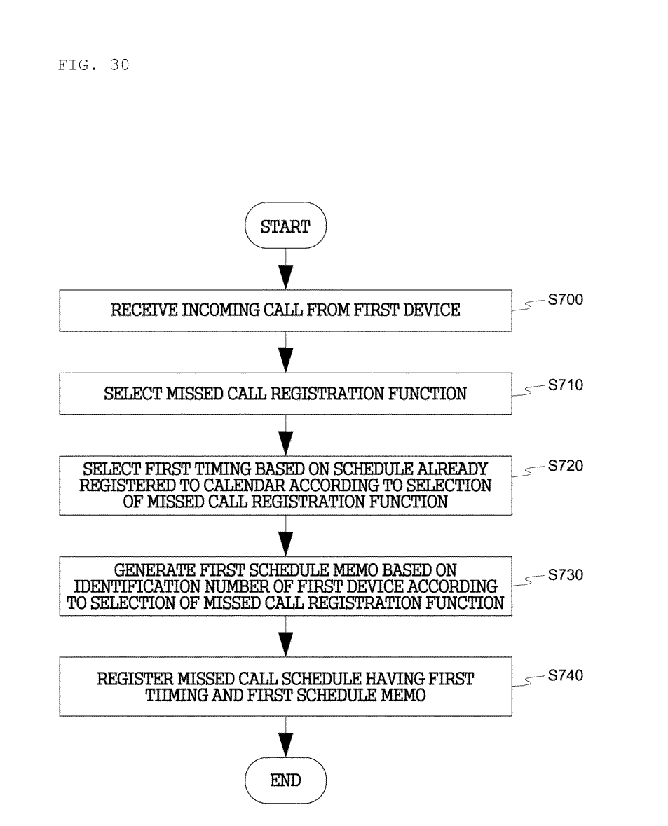

FIG. 30 is a flowchart illustrating a method of controlling a calendar according to another embodiment of the present invention.

Referring to FIG. 30, a method of controlling a calendar according to another embodiment of the present invention may include receiving an incoming signal from a first device in operation S700, selecting a missed call registration function in operation S710, selecting a first timing based on a schedule already registered to the calendar according to a selection of the missed call registration function in operation S720, generating a first schedule memo based on the identification number of the first device according to a selection of the missed call registration function S730, and registering a missed call schedule having the first timing and the first schedule memo to the calendar in operation S740.

Hereinafter, each operation is described in detail.

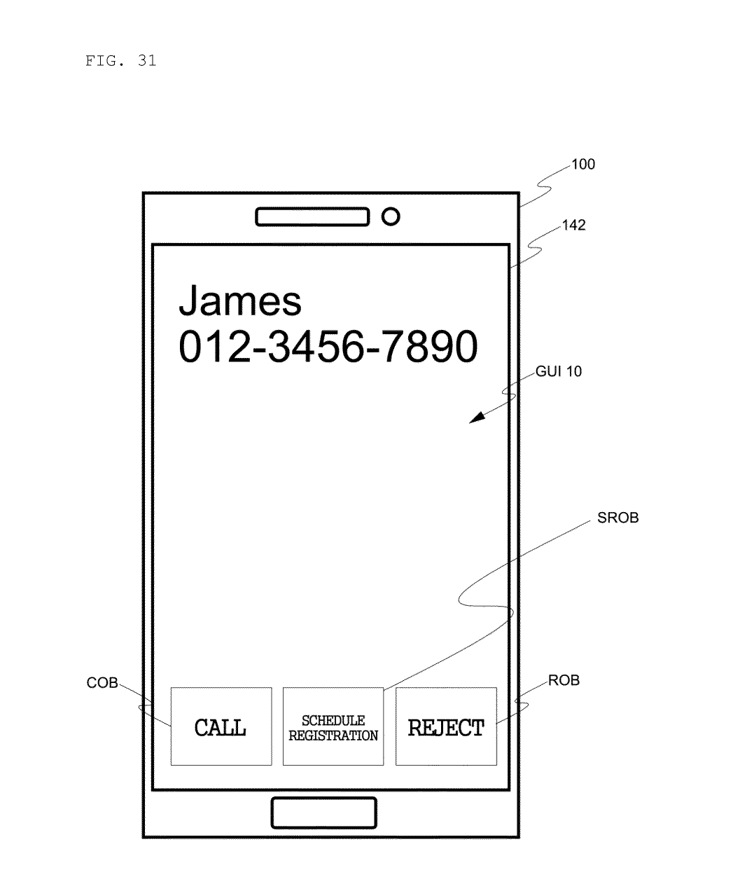

FIGS. 31 to 33 are views illustrating a method of controlling a calendar according to another embodiment of the present invention.

The electronic device 100 may receive an incoming signal from another electronic device in operation S700. For example, the electronic device 100 may receive an incoming signal through a mobile communication network or VoIP network by using the communication unit 110.

At this point, the electronic device 100 may select a missed call registration function at the request of a user or at the request of OS of the electronic device 100 and/or another application installed on the electronic device 100 in operation S710.

The electronic device 100 may provide a UI for selecting a missed call registration function at the request of a user. FIG. 31 illustrates a GUI GUI10 for selecting a missed call registration function according to another embodiment of the present invention. Referring to FIG. 31, when a call is received from the other party, the electronic device 100 may display the other party's name and phone number and in addition to this, display a call reception object COB corresponding to a function for receiving the call and a call rejection object ROB corresponding to a function for rejecting the call. At this point, according to the present invention, it is possible to provide a schedule registration object SROB corresponding to a missed call schedule registration function for registering a schedule for a received call while rejecting the received call. At this point, according to a user's selection for the schedule registration object SROB provided through the GUI GUI10, the electronic device 100 may select the missed call registration function.

When the missed call registration function is selected, the electronic device 100 may select a first timing based on a schedule already registered to the calendar according to a selection of the missed call registration function in operation S720.

In order to perform operation S720, the electronic device 100 may first check whether a schedule including a time point at which the missed call registration function is selected or a time point (hereinafter referred to as a missed call time point) at which an incoming signal is received from the first device is registered to a calendar. That is, when a time point at which the missed call registration function is selected as a call is received is 14:25, if a schedule from 14:00 to 15:00 is registered based on the check result of a schedule registered to a calendar, the electronic device 100 may check that there is a registered schedule at the missed call time point.

If it is checked that there is a registered schedule including a missed call time point, the electronic device 100 may select the first timing based on the end time point of the registered schedule. For example, in the case of the above example, the first timing may be selected as 15:00 or a certain time point (for example, 15:30) after 15:00.

If it is checked that there is no registered schedule including a missed call time point, the electronic device 100 may select a time point after a predetermined time from the missed call time point as the first timing. For example, when the predetermined time is set to 30 min, 14:30 that is 30 min after the missed call time point (14:00) may be set to the first timing. The predetermined time may be a value that is set in advance and changed by a user.

Then, the electronic device 100 may generate a first schedule memo based on the identification number of the first device according to a selection of the missed call registration function in operation S730.

The first schedule memo may include the identification number of the first device (for example, the phone number of the first device).

The first schedule memo may include information (for example, name) on a user of the first device.

The first schedule memo may include information on the missed call time point (that is, a time point at which the missed call is received).

Then, the electronic device 100 may register a missed call schedule having the first timing and the first schedule memo to the calendar in operation S740.

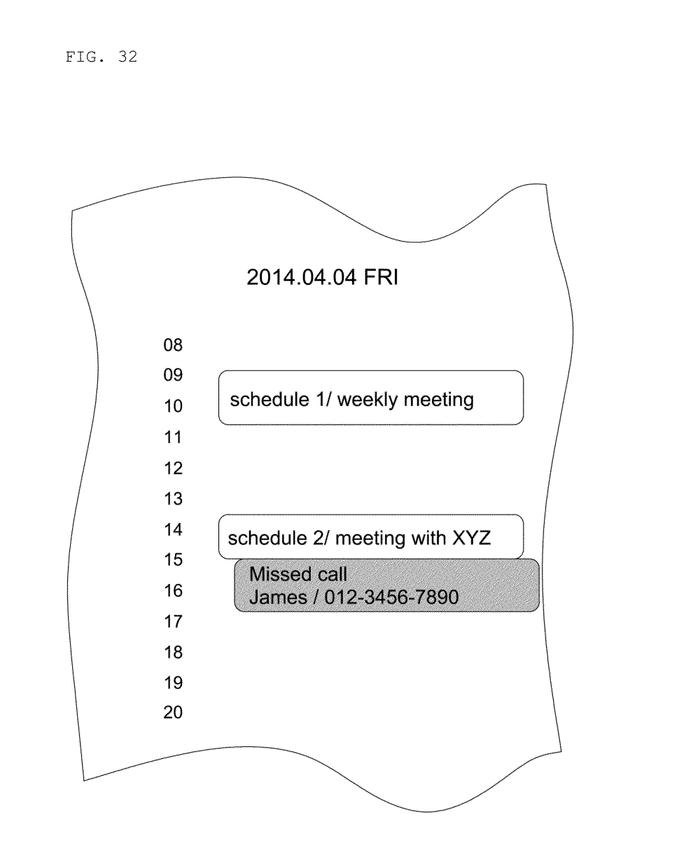

For example, the missed call schedule may be registered as shown in FIG. 32. As shown in the above example, if a corresponding call is not received after a call is incoming at 14:25, as shown in FIG. 32, it is checked that a missed call schedule corresponds to a time point after the end time point of a currently registered schedule.

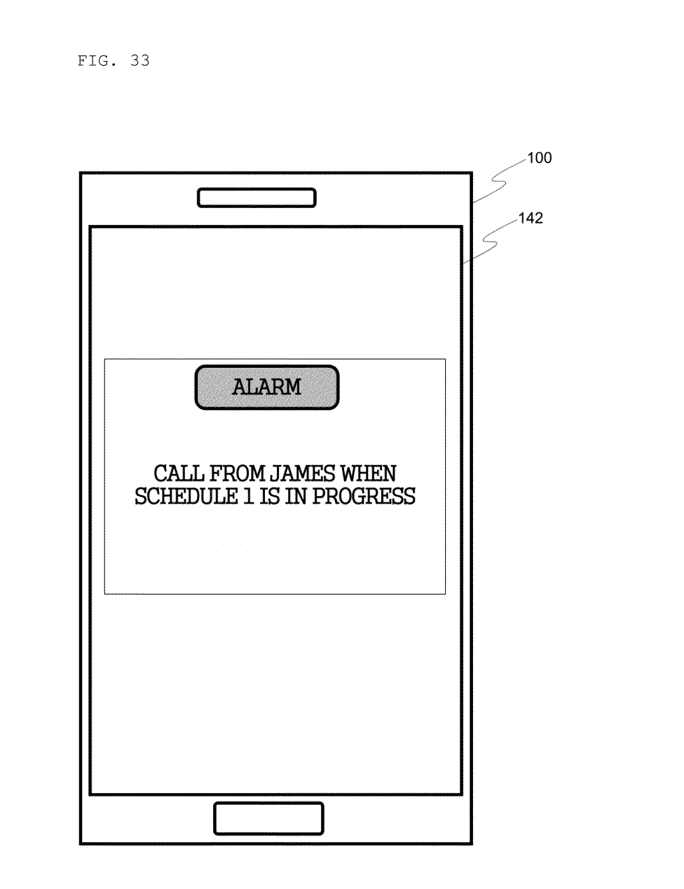

After registering a call schedule missed at the first time point, the electronic device 100, as shown in FIG. 33, may notify that the missed call schedule is registered as a time before a predetermined time after the first timing or the first timing arrives.

Accordingly, a user may not forget that there is a missed call and make a call again to the other party.

When an alarm is displayed to a user as mentioned above, the electronic device 100 may include the identification number (for example, the phone number of the first device) of the first device in the content of the alarm and display it, and transmit a call signal for connecting to the first device according to a selection (for example, touch and/or click) of a user for the identification number of the first device included in the content of the alarm. According to a similar manner, the content of the alarm may include a name for the other party of the missed call and as a user selects the name of the other party, a call signal for connecting to a terminal (that is, the first device) of the other party may be transmitted.

For example, as shown in FIG. 33, “James” that is the other party of a missed call may be displayed on the alarm and a user may make a call to “James” that is the other party of the missed call immediately by selecting “James” (that is, touch or click through a mouse).

One the other hand, after the first timing is selected, the electronic device 100 may transmit a message including information on the first timing to an electronic device (that is, the first device) of the other party of the missed call. For example, when the first timing is determined as 15:30, the message may be written with the content “call back at 15:30. Thanks”.

Alternatively, when the registered schedule including the missed call timing is checked, the electronic device 100 may transmit a message including information on the end time point of the confirmed schedule. For example, when the end timing of the schedule including the missed call timing is 15:00, the message may be written with the content “cannot receive call due to another schedule until 15:00. I will call you back after 15:00. Thanks”. At this point, in transmitting a message that includes information on the end time point of the confirmed schedule, the electronic device 100 may determine whether to transmit the message according to matters set by a user about the registered schedule. For example, when a user registers a schedule, if a call is received during the processing of a registered schedule, the electronic device 100 may provide a UI (for example, a check box) for setting the transmitting of the message in a schedule together, and at this point, the electronic device 100 may create and transmit the message only when a call is received from the outside while a schedule having such a setting is in progress. At this point, if such the setting is not provided, the message may not be transmitted.

Meanwhile, according to the above-mentioned embodiment, although it is described that the missed call schedule registration function is selected by a user while a call signal for call connection is received, the missed call schedule registration function may be automatically selected by the electronic device 100. For example, while a call is received, if a user does not make any response to the received call (for example, the received call is a call during absence), the electronic device 100 may perform the above operations in a similar manner without selecting the missed call schedule registration function of the user, so that a missed call schedule for the call during absence may be registered.

As mentioned above, when a user misses a call received from the other party, according to the present invention, the missed call may be immediately registered as a schedule and accordingly, this induces a user to make a call to the other party without forgetting.

Additionally, when a user tries to make a call to the other party of the missed call, as providing an interface for making a call to the other party again by a selection on information (for example, the identification number (for example, the phone number) of the other party electronic device or the name of the other party) included in an alarm, the user may make a call to the other party of the missed call more conveniently.

Above, a method of controlling a calendar is described according to various embodiments of the present invention.

A control method according to the present invention may be implemented in a code or program form for executing the same and such code or program may be stored in a computer readable recording medium.

Examples of the control method stored in a program readable recording medium and distributed are as follows.

Programs for executing the above methods may be recorded on a portable recording medium such as CD-ROM, floppy disk, and flash memory and the portable recording medium may be distributed.

Alternatively, a server including a recording medium (that is, a storage unit such as hard disk) where a program for executing the above methods is recorded is provided and the program may be distributed by using a method that the program transmits its code to an electronic device such as a smartphone and/or a desktop computer of a user at the request of the user through the server.

Alternatively, an electronic device including a recording medium (that is, an internal memory) where a program for executing the methods is stored may be manufactured by the manufacturer of the electronic device, and the program may be distributed through such a method of distributing the electronic device.

In relation to a control method according to the present invention, operations for configuring each embodiment are not essential and each embodiment may selectively include the above-mentioned operations. Furthermore, each operation configuring each embodiment is not necessarily performed according to the described order and the operations described later may be performed first before the operations described earlier.

The present invention described above, since a number of substitutions, modifications, and changes are possible by a person of ordinary skill in the art within the scope and spirit of the present invention is not limited to the above-mentioned embodiments and accompanying drawings. Additionally, the embodiments described in this specification are not limited to be applied and entire or part of each embodiment may be selectively combined and configured so that various modifications may be made. Furthermore, operations configuring each embodiment may be used separately or in combination of operations configuring another embodiment.

1. A method of displaying weather information on an electronic device, the method comprising:
receiving weather information including first weather information on a first weather at a first time point and second weather information on a second weather at a second time point that is after the first time point, wherein the first weather and the second weather are different;
displaying a first weather object corresponding to the first weather from among a plurality of weather object groups through a display of the electronic device;
displaying a second weather object corresponding to the second weather from among the plurality of weather object groups through the display; and
displaying a difference value between the first time point and the second time point through the display.

2. The method of claim 1, wherein the weather information comprises weather type information and meteorological information, and the meteorological information comprises at least one of temperature information, humidity information, precipitation information, precipitation probability information, wind speed information, and wind direction information.

3. The method of claim 2, wherein the weather type information comprises at least sunny, cloudy, rainy, and snowy.

4. The method of claim 1, wherein the plurality of weather object groups comprise objects respectively corresponding to a plurality of weather types.

5. The method of claim 1, further comprising displaying the meteorological information at the first time point at a position corresponding to a display position of the first weather object.

6. The method of claim 1, further comprising obtaining a position of the electronic device, wherein the weather information is about the obtained position of the electronic device.

7. A method of displaying weather information on an electronic device, the method comprising:
receiving a plurality of weather information corresponding to a plurality of time points, wherein each of the weather information comprises weather type information;
selecting first weather information corresponding to a current time point from among the plurality of weather information;
displaying a first weather object corresponding to first weather type information of the first weather information through a display of the electronic device;
checking at least one second weather information having second weather type information different from the confirmed first weather type information, from among weather information corresponding to time points after the current time point;
displaying a second weather object corresponding to the second weather type information of the confirmed second weather information through the display; and
displaying a difference value between a time point corresponding to the second weather information and the current time point through the display.

8. A method of controlling a calendar including weather information in an electronic device, the method comprising:
displaying a date through a display of the electronic device;
receiving a weather function activation request at a first time point;
selecting dates before the first time point from among the displayed dates;
obtaining weather information corresponding to the selected dates; and
displaying the obtained weather information to correspond to positions of the selected dates through the display.

9. The method of claim 8, wherein the receiving of the weather function activation request comprises receiving a selection input from a user by a weather function object including a first weather object corresponding to the first time point and a second weather object corresponding to a second time point.

10. The method of claim 9, wherein weather type information corresponding to the first time point and weather type information corresponding to the second time point are different.

11. The method of claim 10, wherein the weather object comprises a difference value between the first time point and the second time point.

12. The method of claim 9, wherein the selecting of the dates comprises:
selecting one of the first weather object and the second weather object, included in the weather function object; and
selecting dates having weather type information identical to weather type information corresponding to the selected weather object.

13. The method of claim 8, wherein the displaying of the weather information comprises displaying a weather object corresponding to weather type information corresponding to the selected date from among a plurality of date objects, through the display.

14. The method of claim 13, wherein the displaying of the weather information comprises displaying a maximum value and a minimum value about at least one meteorological information included in the weather information to correspond to the weather object through the display.

15. The method of claim 8, wherein the displaying of the weather information comprises displaying the weather information at schedule information positions respectively corresponding to the displayed dates and displaying schedule information corresponding to the displayed dates.

16. The method of claim 15, wherein the displaying of the weather information comprises no longer displaying the schedule information at the schedule information positions and displaying the weather information instead of the schedule information.

17. A recording medium in which a program for executing the method of any one of claim 1 to claim 16 is recorded.

18. An electronic device comprising:
a communication unit;
a display; and
a control unit configured to receive weather information including first weather information on a first weather at a first time point and second weather information on a second weather at a second time point that is after the first time point through the communication unit, display a first weather object corresponding to the first weather from among a plurality of weather object groups through the display, display a second weather object corresponding to the second weather from among the plurality of weather object groups through the display, and display a difference value between the first time point and the second time point through the display,
wherein the first weather and the second weather are different.
